(19) United States
(12) Patent Application Publication
(10) Pub. No.: US 2026/0230837 A1
(43) Pub. Date: Aug. 6, 2026

(54) DEFINING OPERATIONS TO BE PERFORMED AT CELL SITES OF AN OPEN RADIO ACCESS NETWORK

(71) Applicants: DISH Wireless L.L.C., Littleton, CO (US); DISH Network Technologies India Private Limited, Karnataka (IN)

(72) Inventors: Orlando Cuavas, Littleton, CO (US); Rama Krishna Ganagalla, Andhra Pradesh (IN)

(21) Appl. No.: 19/045,387

(22) Filed: Feb. 4, 2025

(51) Int. Cl. H04W 16/18; H04L 41/0803; H04L 67/00; H04W 24/04

(52) U.S. Cl. CPC H04W 16/18; H04L 41/0803; H04L 67/34; H04W 24/04

(57) ABSTRACT

Techniques are described for defining operations to be performed at one or more remote cell sites. An example method includes receiving an indication to define an automation to be performed at cell sites of a cellular network; determining one or more operations to perform the automation; determining first instructions associated with a first brand of component deployed at one or more cell sites of the cellular network; determining second instructions associated with a second brand of the component deployed at one or more cell sites of the cellular network; associating the first instructions with the automation and the second instructions with the automation; and causing the automation to execute at one or more of the cell sites when determined.

### BACKGROUND

With the increasing adoption of 5G cellular networks, organizations are often reliant on third-party suppliers/vendors to provide physical devices and specialized software services for deployment on these networks and provisioning various services to end-users. The evolution of 5G networks has brought about the advent of open radio access networks (O-RAN) and virtualization, allowing cellular network components to be implemented as software on general-purpose hardware platforms.

During or after deployment of components/devices within a cellular network, different operations may be performed on the components. For example, one or more components may need to be updated (e.g., to a latest software version), reconfigured, rebooted, and the like. For example, RUs, DUs, CUs, computing devices, and the like may need to be updated, reconfigured, and rebooted. Interacting with the components/devices at remote cell sites, as well as performing operations on the components/devices, however, can be extremely challenging. For example, significant time and resources may be needed to perform operations on the different components/devices across thousands of cell sites.

### SUMMARY

In accordance with some embodiments of the present disclosure, a computer-implemented method is provided. In one example, the method includes receiving, by one or more processors, an indication to define an automation to be performed at cell sites of a cellular network; determining, by the one or more processors, one or more operations to perform the automation; determining, by the one or more processors and based at least in part on the one or more operations, first instructions associated with a first brand of component deployed at one or more cell sites of the cellular network; determining, by the one or more processors and based at least in part on the one or more operations, second instructions associated with a second brand of the component deployed at one or more cell sites of the cellular network; associating, by the one or more processors, the first instructions with the automation and the second instructions with the automation; and causing the automation to execute at one or more of the cell sites when determined.

In accordance with some embodiments of the present disclosure, a system is provided. In one example, the system includes: components deployed at cell sites of the cellular network; and an automation manager installed a location that is remote from the cell sites, the automation manager configured to perform actions, including to: receive an indication to define an automation to be performed at cell sites of a cellular network; determine one or more operations to perform the automation; determine, based at least in part on the one or more operations, first instructions associated with a first brand of component deployed at one or more cell sites of the cellular network; determine, based at least in part on the one or more operations, second instructions associated with a second brand of the component deployed at one or more cell sites of the cellular network; associate the first instructions with the automation and the second instructions with the automation; and cause the automation to execute at one or more of the cell sites when determined.

In accordance with some embodiments, the present disclosure also provides a non-transitory machine-readable storage medium encoded with instructions, the instructions executable to cause one or more electronic processors of a system to perform any one of the methods described in the present disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example system architecture of an O-RAN, in accordance with the present disclosure.

FIG. 2 illustrates a system architecture of a 5G O-RAN implemented in a cloud, in accordance with the present disclosure.

FIG. 3 illustrates an example hybrid cellular network system, in accordance with the present disclosure.

FIG. 4 illustrates an example system that can facilitate operations within a telecommunication network, in accordance with the present disclosure.

FIG. 5A illustrates an example process for setting up, provisioning, and operating an O-RAN, in accordance with the present disclosure.

FIG. 5B illustrates an example process showing an example of how ZTP and CI/CD are facilitated in an O-RAN, in accordance with the present disclosure.

FIG. 6 illustrates an example of a cellular network system, in accordance with the present disclosure.

FIG. 7 illustrates an example of a communications system for deploying software from different vendors within a cellular network, in accordance with the present disclosure.

FIG. 8 illustrates an example user interface for defining automations to perform at one or more cell sites, in accordance with the present disclosure.

FIG. 9 illustrates an example user interface for viewing data about operations of an automation, in accordance with the present disclosure.

FIG. 10 illustrates an example user interface for defining automations to perform at one or more cell sites, in accordance with the present disclosure.

FIG. 11 is a flow diagram illustrating an example method for defining automations, in accordance with the present disclosure.

FIG. 12 is a flow diagram illustrating an example method for selecting and performing one or more automations at one or more cell sites, in accordance with the present disclosure.

FIG. 13 is a flow diagram illustrating an example method for determining what cell sites to connect to and what operations to perform, in accordance with the present disclosure.

FIG. 14 is a flow diagram illustrating an example method for performing data validation operations associated with automation operations, in accordance with the present disclosure.

FIG. 15 is a flow diagram illustrating an example method for validation and fallout handling, in accordance with the present disclosure.

FIG. 16 is a schematic diagram illustrating an example computer system or computer device, in accordance with the present disclosure.

### DETAILED DESCRIPTION

The present disclosure provides techniques related to defining operations to be performed at cell sites of an Open Radio Access Network (RAN). Current techniques to perform a task at a cell site, or at some other location within a cellular network, requires a user to manually determine the operations to perform, as well require the user to configure parameters to perform the operations. Further, in some cases, the parameters may be entered incorrectly by the user, thereby causing the operations to fail. Additionally, current techniques require a user who defines the operations to be proficient in the operations being performed. Prior techniques are very inefficient and costly compared to the techniques described in this document.

Using techniques described herein, instead of having to manually define the operations of an automation to complete a task, a user can easily create an automation that can be performed at one or more remote cell sites, and/or within a cellular network. In some examples, an automation manager generates a user interface that allows a user to easily define an automation that includes operations to be performed at one or more cell sites. As used herein, the term “automation” refers to the execution of one or more steps/instructions/operations to complete a desired task.

In some examples, the user defines an automation using a graphical user interface (GUI). The user can select/define operations to be performed within a cellular network, such as at one or more cell sites. For instance, an automation can be defined that include one or more operations associated with a radio unit (RU), a distributed unit (DU), a centralized unit (CU), a sensor deployed at a cell site, an environmental monitoring unit (EMU), a computing device, and the like. In some examples, the automation may relate to a task to reboot one or more devices, update a configuration of one or more devices, and the like.

According to some configurations, the user may interact with user interface (UI) elements of a GUI, or some other type of user interface (UI) (e.g., using voice input, command line input, . . . ), to define/refine an automation. For example, a user may define an RU automation that includes an operation to perform an upgrade of an RU, and another operation to perform an RU restart at one or more cell sites. The RU automation could be to upgrade and restart any brand of RU that may be deployed at a cell site. In some configurations, the automation manager, or some other device or component, may determine the type/brand of RUs deployed at a cell site and select the operations to perform to restart the RU based on the brand. If more than one type of RU is deployed at a cell site, the automation manager may select a first set of instructions to perform for the first type of an RU and select a second set of instructions to perform for a second type of RU. Similarly, the automation tool may perform different automations at different cell sites based on the brand/type of component deployed at each of the cell sites.

In some examples, the UI to define the automations includes UI elements to specify who is authorized to perform the automations. As an example, the user may authorize a first user to perform all automations, whereas the user may authorize a second user to only perform a portion of the available automations. For instance, a user may be authorized to select an automation to reboot a server, whereas a second user may not be authorized to reboot a server. A user may also specify where to perform the automation (e.g., at a single cell site or a group of cell sites).

In addition to interacting with different brands/types of components deployed at the cell sites and/or other locations, the automation manager can analyze data received from the different components for different purposes. For instance, the data can be analyzed by the automation manager to identify a health of all/portion of different components of the different cell sites. Additionally, the automation manager integrates with other components/devices of the O-RAN (e.g., validation/testing tools, data sharing services, and the like). For instance, the automation engine may interact with an inventory management component to determine information about the components deployed at one or more cell sites, interact with a validation engine to determine if an automation has been completed successfully, interact with a workflow engine to cause one or more workflows to be completed based on the selected automation to perfume, and the like. As briefly discussed above, using prior techniques, it was very difficult for users to define automations that included operations to perform at remote cell sites that include different brands of components provided by different suppliers/vendors. Each different brand of a component deployed at a cell site may use different parameters, may provide different application programming interfaces (APIs), and/or may provide different functionality. Instead, operators would be restricted to interacting with components with which they have proficiency. For instance, a user may only be familiar with a single brand of RU, or some other type of component deployed at a cell site. Further, it was very difficult to determine if the operation requested to be performed was completed successfully. Using the techniques described herein, one or more automations can be defined and remotely performed at one more cell sites that can different brands of components deployed. Using techniques described herein, an automation defined using the UI seamlessly integrates with different brands of components, inventory management tools, network monitoring tools, validation/testing tools, data sharing services, and the like. In some examples, the automation component is configured to register and catalog supported/installed components.

Instead of a user having to travel to cell sites to perform an operation, a user can define and perform operations remotely and view data from different brands of components deployed at the different cell sites using the automation component. For instance, the automation management component can be used to view data provided by different brands of components, add/remove/configure/restart one or more components, as well as perform other operations. In some examples, the automation management component communicates directly with a cell site router deployed at a cell site and/or communicate directly within one or more components deployed at a cell site including components from different vendors using one or more application programming interfaces (APIs) to obtain data, perform health checks, perform upgrade operations, restart operations, configuration operations, and the like.

The automation manager may also interact directly with different monitoring components to detect cell site conditions at one or more of the different cell sites. For example, the automation manager may interact with a health monitor, safety monitor, power monitor, and/or some other monitor.

The automation manager is also configured to create payloads based on the type and brand of component being interacted with. In some examples, when a configuration change is made to a component using an automation, an inventory component, a site management component, an element management system (EMS), or some other data is automatically updated to reflect the change. The techniques described herein can be used to interact with a large number of cell sites and components from different vendors, resulting in a significant cost and time savings.

### Example O-RAN

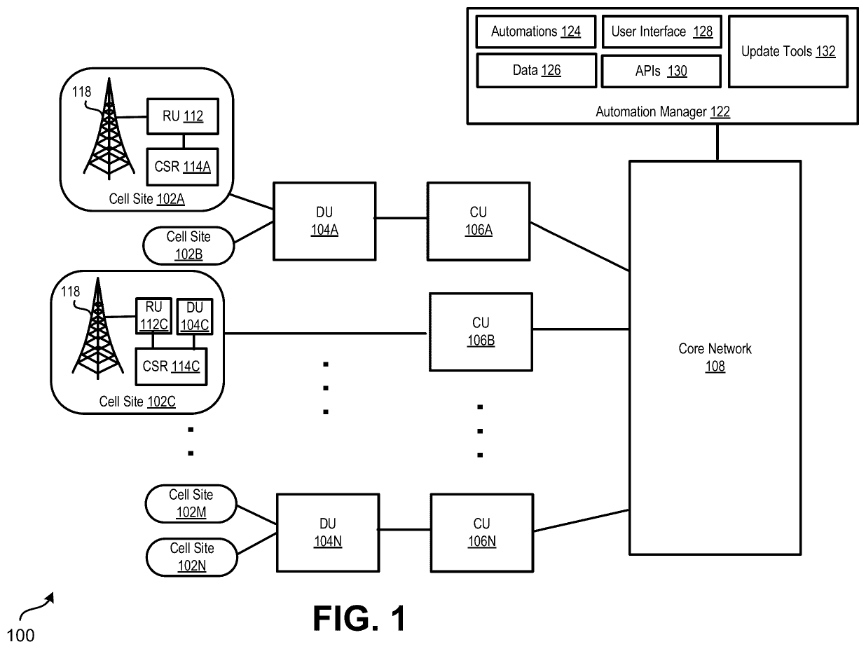

As shown in FIG. 1, the example system architecture 100 of an O-RAN in accordance with the present disclosure comprises multiple cell sites, such as cell sites 102A, B, C, D, . . . , N, N+1. As illustrated in this example, within a given cell site, such as 102A, one or more radio units (RU) are installed in the O-RAN in accordance with the present disclosure. A given one of the RUs, such as RU 112, in a given cell site, such as cell site 102A and cell site 102C, comprises hardware components such as radio frequency (RF) transceivers, antennas configured to transmit and receive RF signals from/to end user equipment (UE), such as smartphones.

As illustrated, a cell site 102, such as cell site 102A includes a CSR 114 coupled to RU 112. In various implementations, RUs and DUs in different cell sites 102 in the example system architecture 100 can be provided by different hardware vendors. While CSRs 114 are only illustrated in cell site 102A and 102C, a CSR 114 can be included in all, or a portion, of the cell sites 102A-102N. It is contemplated that in some embodiments, the cell sites in the example system architecture 100 are heterogenous in terms of hardware they are implemented in.

Also shown in FIG. 1 are distributed units (DUs) 104A, 104B . . . and 104N. A given one of the DUs, such as 104A in this example, is configured to facilitate real-time baseband processing function. Various protocols can be configured into the given DU, such as RLC, PDCP MAC and/or any other lower-level protocols. In various implementations, the given DU is configured to communicate with at least one RU in a cell site. For example, as shown in this example, the DU 104A is configured to communicate with the RUs in cell sites 102A and 102B, the DU 104A is configured to communicate with the RUs in cell sites 102C and 102D, and DU 104N is configured to communicated with the RUs in cell sites in 102N and 102N+1. In some examples, a cell site 102, such as cell site 102C, can include a DU, such as DU 104C. It should be understood that the communications illustrated between the DUs and the cell sites in FIG. 1 are merely illustrative and thus should not be understood as limiting a scope of the O-RAN in accordance with the present disclosure. That is, the O-RAN in accordance with the present disclosure is not limited to one DU connected only to two cell sites as illustrated in FIG. 1. One skilled in the art understands that the O-RAN in accordance with the present disclosure can comprise a DU configured to however many cell sites.

A given communication link between a given DU and given RU in a cell site is typically referred to as a fronthaul haul—for example, the links between cell sites 102A/B and DU 104A. In that example, the DU 104A is configured to consolidate and process inbound traffic from RUs in the cell sites 102A/B, distributes traffic to the RUs in the cell sites 102A/B. In implementations, the DUs can be located near the cell sites they have communication with or centralized in a local data center provided by a vendor. In some implementations, various functionalities in the DUs can be implemented using software.

Still shown in FIG. 1 are centralized units (CUs), such as CU 106A, 106B, and 106N. A given one of the CUs is configured to handle higher layers of communication protocols as compared to a DU. For example, less time-sensitive packet processing, such as SDAP, RRC or PDCP, may be implemented in the given CU. It should be understood that functionality split between CU and DU is not intended to be specifically limited in the present disclosure. It is understood that such a split can be a design choice for a particular O-RAN. That is, the present disclosure should not be understood as being limited to a specific version or specific versions of O-RAN, where splits between CU and DU are specifically defined. For example, a DU may be separate from the RU and a CU, the DU can be co-located with the CU, or the DU can be bundled with the RU. The DU can also run standalone and/or be within a pool of DUs. Collectively, RUs, DUs, and a CU can create a gNodeB, which serves as a radio access network (RAN) of example system architecture 100.

In implementations, CUs in an O-RAN in accordance with the present disclosure can be implemented using software. In some embodiments, the given CU may be located in a data center provided by a third-party vendor. In some embodiments, one or more of the given CU can be located in the data center. The individual links between a CU and DU is typically referred to as a midhual link, for example the link between 104A and 106A shown in this example.

FIG. 1 also shows a core network 108. The core network 108 is configured to enable end users to access services such as phone calls, internet, etc. In various embodiments, the core network 108 is configured to handle operations such as subscriber location, profile, authentication, and/or any other operations. In those embodiments, such operations can facilitate the end users to employ communication technologies (such as 5G) through the example system architecture 100. In some embodiments, the services and/or operations provided by the core network 108 are implemented using software. Although only one core network 108 is shown in FIG. 1, this is not intended to be limiting. It should be understood the example system architecture 100 is not intended to be limited to 5G. It is understood embodiments provided herein can be applied to other types of cell sites when appropriate, such as LTE, 3G, 6G, WIFI or any other types of networks.

In various other examples, more than one core network 108 can be included in the O-RAN in accordance with the present disclosure. Links between a CU and the core network 108 are typically referred to as backhaul links, for example, the link between CU 106A and core network 108 shown in this example. The fronthaul links, midhaul links, and backhaul links shown in FIG. 1 may be collectively referred to as a transport layer for the example system architecture 100. In various embodiments, the transport layer is configured to handle end-to-end communication over the O-RAN in accordance with the present disclosure.

As illustrated, an automation manager 122 is coupled to the core network 108. The automation manager 122, is configured to interact with different devices/components deployed within a cellular network, such as the RUs 112, DUs 104, CSRs 114, and other devices/components deployed at cell sites 102. Instead of having to manually determine the operations to perform to complete a task, a user can easily define and cause one or more automations/operations to be performed at one or more remote cell sites 102. In some examples, an automation manager 122 allows a user to easily define an automation using a GUI, or some other UI, and then select an automation (e.g., from automations 124) that includes operations to be performed at one or more cell sites 120.

As briefly discussed above, the automation manager 122 is configured to interact with different brands of devices/components provided by different suppliers/vendors using the same application/tool/UI. For instance, the automation manager 122 may interact with RUs from different vendors at one or more of the cell sites 102. In some examples, the automation manager 122 connects to a cell site 102 using a CSR 114 deployed at the cell site 102. In some examples, the CSR 114 may be connected to the different devices deployed at a cell site (e.g., server computing devices, environmental management units/systems (EMUs), antennas, RUs, DUs, sensors, . . . ).

The automation manager 122 can integrate with different tools such as but not limited to different brands of components (e.g., RUs, DUs, CUs, element management systems (EMSs), inventory management tools, network monitoring tools, validation/testing tools, and the like). In some examples, automation manager 122 is configured to define operations and automations and perform automations at one or more cell sites 102. According to some examples, application programming interfaces 130 can be used to interact with functionality provided by different components/devices. The APIs 130 may be provided by a hardware vendor, and/or be custom APIs developed to interact with different components.

In some examples, the automation manager 122 is configured to generate a UI, such as UI 128, to define an automation and specify what automations to perform. According to some configurations, the user may select operations to include within an automation from UI 128, such as a graphical user interface (GUI) or some other type of user interface (UI) (e.g., using voice input, command line input, . . . ). For example, a user may define an automation that includes one or more operations to perform an RU restart at one or more cell sites 102. The RU restart automation could be to restart any brand of RU that may be deployed at a cell site. In some configurations, an automation, such as the RU restart automation may include an operation to determine the type/brand of RUs deployed at a cell site and select the automation to perform to restart the RU based on the brand. If more than one type of RU is deployed at a cell site, the automation manager may select instructions associated with the particular type/brand of RU to perform the automation. Stated another way, an automation can include different instruction sets that are associated with each different brand of component associated with the automation. For example, the automation manager 122 may generate/obtain a first set of instructions to perform one or more operations for a first type of component, generate/obtain a second set of instructions to perform one or more operations for a second type of component, and the like. When the automation is performed, the automation manager 122 may select the appropriate instructions to perform based on the type of component.

The UI 128 may also be used to select one or more cell sites 102 to perform the automation. For instance, a user may specify a single cell site identifier or may identify more than one cell site to connect to and perform the operations. As an example, a user may specify to reboot one or more servers at one or more cell sites, update all of the RUs 112/DUs 104 that are associated with a particular vendor or multiple vendors, perform one or more operations that affect a single device/component, perform one or more operations that affect many different devices/components, and the like. The UI 128 may also be used to specify one or more automations to be performed at the identified cell sites 102. According to some configurations, the automation manager 122 accesses data (e.g., data 126) to identify what components/devices are installed at different cell sites 102. In some examples, the data 126 can also include executable code that is used to perform one or more operations at one or more cell sites 102.

In some examples, the automation manager 122 determines the automations displayed within the UI 128 and/or available to the user to define and/or perform are based on automation(s) that the user is authorized to perform. As an example, a first user may be authorized to perform all automations, whereas a second user may be authorized to perform a portion of the available automations. For instance, a user may be authorized to select an automation to reboot a server, whereas a second user may not be authorized to reboot a server. A user may also specify where to perform the automation (e.g., at a single cell site or a group of cell sites).

In some configurations, the automation manager 122 determines the IP addresses to connect to within a cell site 102 to perform one or more automations, establish a network connection using the determined IP addresses, and then causes the operations associated with an automation to be performed. In some configurations, the automation manager 122 can create payloads based on the selected automation. In some examples, when a configuration change is made by performing an automation, an element management system (EMS) (not shown) is automatically updated to reflect the change. These techniques can be used to interact with a large number of cell sites 102, resulting in a significant cost and time savings.

According to some configurations, the automation manager 122 identifies contextual information about the automation to update and customizes the operations to fit the specifications to perform an automation. For example, one operation for a first brand of a component/device may use six operations to perform the automation, whereas another brand of the component/device may use two operations to perform the automation.

In some configurations, the automation manager 122 causes/performs a health check before performing the automation and well as after performing the automation. In some examples, the health check determines a current version of the component/device, whether the component/device is operating as intended, whether the component/device is reachable using an assigned IP address, and the like. The health check before the automation may be used to determine that the operation is able to performed. The automation manager 122 also identifies any dependencies associated with one or more of the operations to be performed. In some cases, the automation manager 122 determines if one or more other components/devices are to be updated before/after performing an operation. For example, one brand of DU may specify to update the associated RU before/after updating the DU.

In some configurations, the automation manager 122 may cause one or more update tools 132 to perform one or more operations relating to performing an operation associated with an automation. For example, a component/tool provided by the vendor of a component/device to perform operations relating to the component/device can be used (e.g., using an API 130). In some configurations, the automation manager 122 can also create payloads for the update tools that are specific to the operation being performed. As another example, the automation manager 122 interacts with an inventory component such that configuration information for the component/device is automatically updated and the inventory component for the cellular network is up to date.

Using techniques described herein, an automation component seamlessly integrates with different brands of components, inventory management tools, network monitoring tools, validation/testing tools, data sharing services, and the like. In some examples, the automation component is configured to register and catalog supported/installed components. In addition to interacting with different brands/types of components deployed at the cell sites and/or other locations, the automation manager can analyze data received from the different components for different purposes. For instance, the data can be analyzed by the automation manager to identify a health of all/portion of different components of the different cell sites. Additionally, the automation manager integrates with other components/devices of the O-RAN (e.g., validation/testing tools, data sharing services, and the like). For instance, the automation engine may interact with an inventory management component to determine information about the components deployed at one or more cell sites, interact with a validation engine to determine if an automation has been completed successfully, interact with a workflow engine to cause one or more workflows to be completed based on the selected automation to perfume, and the like.

The automation manager 122 is also configured to create payloads based on the type and brand of component being interacted with. In some examples, when a configuration change is made to a component using an automation, an inventory component, a site management component, an element management system (EMS), or some other data is automatically updated to reflect the change. The techniques described herein can be used to interact with a large number of cell sites and components from different vendors, resulting in a significant cost and time savings.

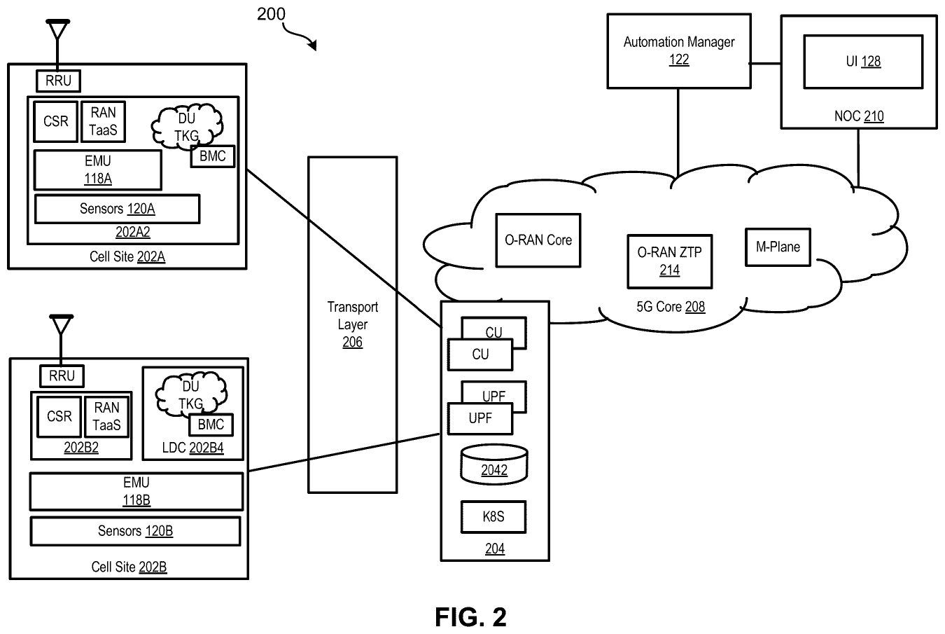

With an example system architecture 100 of O-RAN in accordance with the present disclosure having been generally described and illustrated, attention is now directed to FIG. 2, where an example system architecture 200 of a 5G O-RAN implement in a cloud is generally illustrated.

### Example System Architecture of 5G O-RAN

As shown FIG. 2, the example system architecture 200 of a 5G O-RAN comprises a cell site 202A, a cell site 202B, and/or any other cell site(s). As shown, each of the cell site 202A, and 202B, in this example, includes a remote radio unit (RRU). In this example, one or more computing devices, located outside the cell site 202B, are configured to implement a cell site router (CSR), a DU, a baseband management controller (BMC), a RAN, a RAN TaaS (test as a service), and/or any other components. In some embodiments, the computing device includes a processor configured to implement various components mentioned above. In some examples, the computing device(s) 202A2 includes an operating system such as a Linux system to implement these components. In that example, the computing device(s) 202A2 is located in a cabinet within a proximity of the cell site 202A, and cell site 202A is referred to as a “lite site”.

The cell site 202B includes a computing device 202B2 and another computing device 202B4. In this example, the computing devices 202B2 and 202B4 are located within the cell site 202B. In some examples, the computing devices 202B2 and 202B4 are located in a cabinet within the cell site 202B. In that example, the cell site 202B is referred to as a “dark site”.

As shown, in this example, the computing device 202B2 is configured to implement the CSR, RAN, and/or any other components, while the computing device 202B4 is configured to implement the DU (for example, hosting Tanzu Kubernetes Grid (TKG)), BMC, and/or any other components. This is to show cell sites in a 5G O-RAN in accordance with the present disclosure can have computing devices located within the cell sites and configured to implement various components whose functionalities attributed to the DU, CSR or RAN. That is, the 5G O-RAN in accordance with the present disclosure is not intended to be limited such that DU and CSR/RAN are implemented on different computing devices, and/or outside the cell site. In some embodiments, the RAN for a specific cell site such as 202A or 202B can include tests designed to components and functionalities within the specific cell site, functionalities with another cell site (e.g., adjacency testing), and/or end-to tend testing.

In various embodiments, the RAN shown in this example is implemented using software and is configured to test and ensure one or more O-RAN components (e.g., the RRU or CSR, in the cell sites are performing in compliance with O-RAN standards). Various tests or test suites can be configured into a RAN to cause target components in the cell sites to be run under preset test conditions. A goal of such a test or test suite in the RAN is to verify that individual components in the cell sites can handle expected traffic and functionality. In some embodiments, tests in the RAN are run continuously on a preset or configured frequency to ensure the above-mentioned types of testing of the specific cell sites are in compliance with the O-RAN standards continuously.

As shown FIG. 2, the cell sites 202A and 202B are connected, via the transport layer 206, to a data center 204 configured to host one or more CUs, and one or more UPFs (user plane functions) implementing at least one user plane layer, and/or any other components. In some examples, the data center 204 is referred to as a breakout edge data center (BEDC). In general, the data center 204 is configured to accommodate the distributed nature of various functions in the example system architecture 200 of a 5G O-RAN. In that example, the BEDC hosts various 5G network functions (NFs) that have low latency requirement. In that example, the BEDC provides internet peering for general 5G service and enterprise customer-specific private network service.

Shown in this example is a storage 2042 configured to store various (Cloud-native Network Functions) CNFs and artifacts for facilitating implementations of the DUs and CUs in the example system architecture 200 of the 5G O-RAN. Examples of the storage 2042 can include Amazon S3, GitHub, Harbor and/or any other storage services.

In some embodiments, such as shown in FIG. 2, the data center 204 can include one or more Kubernetes (also known as K8S) configured to facilitate automation of deployment, scaling, and management of various software/applications deployed within the data center 204 and/or within one or more cell sites operatively communicating with the data center 204 through the transport layer 206.

5G Core 208 can be implemented such that it is physically distributed across data centers or located at a central national data center (NDC) and/or regional data center (RDC). In this example, 5G core 208 performs various core functions of the 5G network. In implementations, 5G core 208 can include an O-RAN core implementing various 5G services and/or functions such as: network resource management components; policy management components; subscriber management components; packet control components; and/or any other 5G functions or services. Individual components may communicate on a bus, thus allowing various components of 5G core 208 to communicate with each other directly. Implementations 5G core 208 can involve additional other components.

Network resource management components can include: Network Repository Function (NRF) and Network Slice Selection Function (NSSF). NRF can allow 5G network functions (NFs) to register and discover each other via a standards-based application programming interface (API). NSSF can be used by AMF to assist with the selection of a network slice that will serve a particular UE.

Policy management components can include: Charging Function (CHF) and Policy Control Function (PCF). CHF allows charging services to be offered to authorized network functions. A converged online and offline charging can be supported. PCF allows for policy control functions and the related 5G signaling interfaces to be supported.

Subscriber management components can include: Unified Data Management (UDM) and Authentication Server Function (AUSF). UDM can allow for generation of authentication vectors, user identification handling, NF registration management, and retrieval of UE individual subscription data for slice selection. AUSF performs authentication with UE.

Packet control components can include: Access and Mobility Management Function (AMF) and Session Management Function (SMF). AMF can receive connection and session related information from UE and is responsible for handling connection and mobility management tasks. SMF is responsible for interacting with the decoupled data plane, creating updating and removing Protocol Data Unit (PDU) sessions, and managing session context with the User Plane Function (UPF).

In one O-RAN implementation, DUs, CUs, 5G core 208 and/or any other components in that O-RAN, is implemented virtually as software being executed by general-purpose computing equipment, such as those in one or more data centers. Therefore, depending on needs, the functionality of a DU, CU, and/or 5G 208 core may be implemented locally to each other and/or specific functions of any given component can be performed by physically separated server systems (e.g., at different server farms). For example, some functions of a CU may be located at a same server facility as where the DU is executed, while other functions are executed at a separate server system. In some embodiments, DUs may be partially or fully added to cloud-based cellular network components. Such cloud-based cellular network components may be executed as specialized software executed by underlying general-purpose computer servers. Cloud-based cellular network components may be executed on a third-party cloud-based computing platform. For instance, a separate entity that provides a cloud-based computing platform may have the ability to devote additional hardware resources to cloud-based cellular network components or implement additional instances of such components when requested.

In implementations, Kubernetes (K8S), or some other container orchestration platform, can be used to create and destroy the logical DU, CU, 5G core units and subunits as needed for the O-RAN to function properly. Kubernetes allows for container deployment, scaling, and management. As an example, if cellular traffic increases substantially in a region, an additional logical DU or components of a DU may be deployed in a data center near where the traffic is occurring without any new hardware being deployed. (Rather, processing and storage capabilities of the data center would be devoted to the needed functions.) When the need for the logical DU or subcomponents of the DU is no longer needed, Kubernetes can allow for removal of the logical DU. Kubernetes can also be used to control the flow of data (e.g., messages) and inject a flow of data to various components. This arrangement can allow for the modification of nominal behavior of various layers.

In implementations, the deployment, scaling, and management of such virtualized components can be managed by an orchestrator (such as Kubernetes) in the 5G core 208. The orchestrator can trigger various software processes executed by underlying computer hardware. In implementations, the one or more management functions (managing the 5G core 208, and/or the example system architecture 200 in general) can be implemented in the 5G core 208, for example through a M-Plane. The M-Plane can be configured to facilitate monitoring of O-RAN and determining the amount and location at which cellular network functions should be deployed to meet or attempt to meet service level agreements (SLAs) across slices of the cellular network.

In various implementations, the orchestrator can allow for the instantiation of new cloud-based components of the example system architecture 200 of the 5G O-RAN. As an example, to upgrade a NF, the orchestrator can perform a pipeline of calling the NF upgrade code from a software repository incorporated as part of, or separate from, cellular network; pulling corresponding configuration files (e.g., helm charts); creating Kubernetes nodes/pods; configuring the NF; and activating other support functions (e.g., connections to test tools).

In some implementations, a network slice functions as a virtual network operating on example system architecture 200 of the 5G O-RAN. In those implementations, example system architecture 200 of the 5G O-RAN is shared with some number of other network slices, such as hundreds or thousands of network slices. Communication bandwidth and computing resources of the underlying physical network can be reserved for individual network slices, thus allowing the individual network slices to reliably meet particular SLA levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus optimization between performance and cost is desirable.

Particular network slices may only be reserved in particular geographic regions. For instance, a first set of network slices may be present at a given RU and a given DU, a second set of network slices, which may only partially overlap or may be wholly different than the first set, may be reserved at the given RU and the given DU.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

In some embodiments, the 5G core 208 implements a O-RAN ZTP (zero touch provisioning) layer. In general, in those embodiments, the O-RAN ZTP layer is configured to facilitate automation of the deployment workflow within the example system architecture 200 of the 5G O-RAN. ZTP is commonly known as automated deployment of software (new or updates) to various components in a system with as little human intervention as possible. In the context of example system architecture 200 of the 5G O-RAN, ZTP means automated deployment of software (new or updates) to hardware and/or software components such as RUs, CSRs, DUs, CUs, and various modules in the 5G core 208 with little human intervention.

For example, without an engineer having to be present at a specific cell site such as 202A or 202B, O-RAN ZTP can facilitate automations such as but not limited to automation for updates of an NF with the latest NF software, updates of an RU with the latest RU software, updates of a DU with the latest DU software and/or changing from one vendor's RU/DU to another vendor's RU/DU. It should be understood the O-RAN ZTP layer is referred to a set of components that work together to facilitate automatic deployment of software in the example system architecture 200 of the 5G O-RAN with little human intervention. Thus, although, the O-RAN ZTP layer is shown being implemented in the 5G core 208 in FIG. 2, it is merely illustrative. That is, the O-RAN ZTP in accordance with the present disclosure is not intended to be limited to components implemented a core of the O-RAN in accordance with the present disclosure. In some other examples, one or more components of the O-RAN ZTP can be implemented in, for example, CUs or DUs in the O-RAN in accordance with the present disclosure. For instance, as will be described below, adaptors configured to communicate with devices or components of different vendors for ZTP operations can be implemented in CUs or DUs.

Also shown in FIG. 2 is a NOC 210 (Network Operation Center). In some embodiments, the NOC 210 is implemented on a general-purpose computing device. In those embodiments, one or more interfaces are implemented in the NOC 210. In those embodiments, the interfaces represent virtual dashboards that can facilitate automatic deployment of software to various components in the example system architecture 200 of the 5G O-RAN. For instance, an interface is provided in the NOC 210 to enable an operator to view data using UI 128 to interact with different components at the difference cell sites, as described herein. According to some configurations, the UI 128 can be used to define automation, request automations, and view data associated with automations.

The NOC 210 can also be used by an operator to set a schedule to update one or more network services in the 5G core 208. As another illustration, an interface is provided in the NOC 210 to enable the operator to push software to a specific component in a cell site (such as 202A or 202B) or in a data center (such as 204) to configure or update the component. As another example, an interface is provided in the NOC 210 to enable an operator to provision one or more C-RAN components.

One or more requests can be generated by the NOC 210 to instigate the deployment of the software as scheduled or intended by the operator. The request(s) can be received by the O-RAN ZTP layer, which in turn can generate one or more commands to deploy the software to the component. Although one NOC 210 is shown in this example, this is not intended to be limiting. More than one NOCs are typically deployed in the example system architecture 200 of the 5G O-RAN. In some implementations, a given NOC may be provided by a vendor to the 5G O-RAN. For instance, the vendor may be a software develop that provides components or services to the example system architecture 200 of a 5G O-RAN. In that instance, the given NOC is a computing device or system on a premise of the software developer.

Components such as EMUs, RUs, DUs, CUs, the orchestrator, O-RAN ZTP layer, interfaces in the NOC 210, and/or any other components in the 5G core 208 may include various software components communicating with each other, handling large volumes of data traffic, and be able to properly respond to changes in the network. In order to ensure not only the functionality and interoperability of such components, but also the ability to respond to changing network conditions and the ability to meet or perform above vendor specifications, significant testing must be performed.

### Example Hybrid Cellular Network System

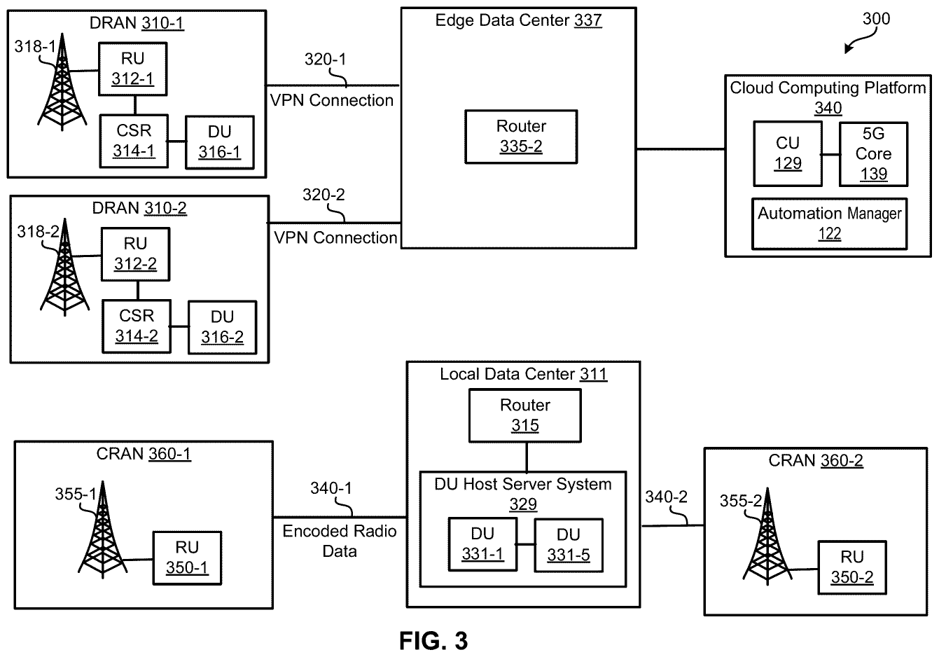

FIG. 3 illustrates an example of hybrid cellular network system 300 that includes hybrid use of local and remote DUs in communication with a cloud computing platform that hosts the cellular network core. System 300 can include: local data center (LDC) 311; cloud radio access networks (CRANs 355), which may also be referred to herein as light BSs 355; distributed radio access networks (DRANs 318)), which may also be referred to herein as full BSs 318; VLAN connections 320; edge data center (EDC) 330; CU 129; and 5G core 139, which are executed on cloud computing platform 340. In system 300, some base stations, referred to as DRAN or “full base stations,” have DUs implemented locally at each BS. In contrast, a CRAN is a “light base station” that includes structure (e.g., structures 355) and a local radio unit (e.g., RUs 350), but a DU implemented remotely at a geographically separated LDC. In system 300, either CRAN/light BSs 355 or DRAN/full BSs 318 may be referred to as a cell site.

LDC 311 can serve to host DU host server system 329, which can host multiple DUs 331 which are remote from corresponding light base stations 355. For example, DU 331-1 can perform the DU functionality for light base station 355-1. DUs with DU host server system 329 can communicate with each other as needed.

LDC 311 can be connected with EDC 330. In some embodiments, LDC 370 and EDC 330 may be co-located in a same data center or are relatively near each other, such as within 250 meters. EDC 330 can include multiple routers, such as routers 335, and can serve as a hub for multiple DRANs 318 and one or more LDCs 311. EDC 330 may be so named because it primarily handles the routing of data and does not host any RAN or cellular core functions. In a cloud-computing cellular network implementation at least some components, such as CU 129 and functions of 5G core 139, may be hosted on cloud computing platform 340. EDC 330 may serve as the past point over which the cellular network operator maintains physical control; higher-level functions of CU 129 and 5G core 139 can be executed in the cloud. In other embodiments, CU 129 and 5G core 139 may be hosted using hardware maintained by the cellular network provider, which may be in the same or a different data center from EDC 330.

DRANs 318, which include on-site DUs 316, may connect with the cellular network through EDC 330. A DRAN, such as DRAN 318-1, can include: RU 313-1; router 335-1; DU 316-1; and structure 323-1. Router 335-1 may have a connection to a high bandwidth communication link with EDC 330. Router 335-1 may route data between DU 316-1 and EDC 330 and between DU 316-1 and RU 313-1. In some embodiments, RU 313-1 and one or more antennas are mounted to structure 323-1, while router 335-1 and DU 316-1 are housed at a base of structure 323-1. DRAN 318-2 functions similarly to DRAN 318-1. While two DRANs 318 and two CRANs 355 are illustrated in FIG. 3, it should be understood that these numbers of BSs are merely for exemplary purposes; in other embodiments, the number of each type of BS may be greater or fewer.

While encoded radio data is transmitted via the fiber optic connections 340 between CRANs 355 and LDC 370, connection 320-1 between DRAN 318 and EDC 330 may occur over a fiber network. For example, while the connection between CRANs BS 355-1 and LDC 370 can be understood as a dedicated point-to-point communication link on which addressing is not necessary, DRAN 318-1 may operate on a fiber network on which addressing is required. Multiprotocol label switching (MPLS) segment routing (SR) may be used to perform routing over a network (e.g., fiber optic network) between DRAN 318-1 and EDC 330. Such segment routing can allow for network nodes to steer packetized data based on a list of instructions carried in the packet header. This arrangement allows for the source from where the packet originated to define a route through one or more nodes that will be taken to cause the packet to arrive at its destination. Use of SR can help ensure network performance guarantees and can allow for network resources to be efficiently used. Other DRANs may use the same types of communication link as DRAN 318-1. While MPLS SR can be used for the network connection between DRANs 318 and EDC 330, it should be understood that other protocols and non-fiber-based networks can be used for connections 320.

For communications across connection 320-1, a virtual local area network (VLAN) may be established between DU 316-1 and EDC 330, when a fiber network that may also be used by other entities is used. The encryption of this VLAN helps ensure the security of the data transmitted over the fiber network.

Since CRANs 355 are relatively close to LDC 370, typically in a dense urban environment, use of a dedicated point-to-point fiber connection can be relatively straight-forward to install or obtain (e.g., from a network provider that has available dark fiber or fiber on which bandwidth can be reserved). However, in a less dense environment, where DRANs 318 can be used, a point-to-point fiber connection may be cost-prohibitive or otherwise unavailable. As such, the fiber network on which MPLS SR is performed and the VLAN connection is established can be used instead. Further, the total amount of upstream and/or downstream data from a CRAN to an LDC may be significantly greater than the amount of upstream and/or downstream data from a DU of a DRAN to EDC 337, thus requiring a dedicated fiber optic connection to satisfy the bandwidth requirements of CRANs.

Real-world implementations of system 300 can include many (e.g., thousands) of BSs and many CUs. BSs can include one or more antennas that allow RUs to communicate wirelessly with UEs (not shown). RUs can represent an edge of cellular network where data is transitioned to RF for wireless communication. The radio access technology (RAT) used by an RU may be 5G NR, or some other RAT.

The cloud computing platform 340 includes an automation manager 122 configured to perform operations described herein.

### Example System to Facilitate C-RAN Using ZTP Operations

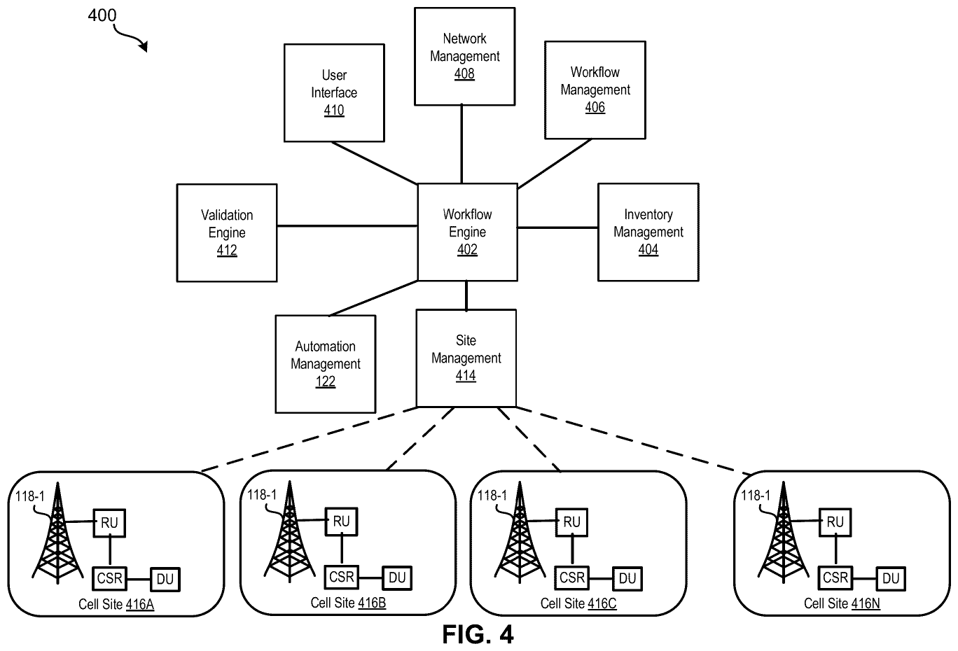

FIG. 4 illustrates an example system 400 that can facilitate C-RAN operations within a telecommunication network, such as the ones shown in FIG. 1, FIG. 2, or FIG. 3, in accordance with some embodiments. In this example, the system 400 includes a site management component 414, an inventory management component 404, a workflow engine 402, a workflow management component 406, a network management component 408, a user interface 410, a validation engine 412, an automation management component 122, and/or any other components. As also shown, the various components in the example system 400 are operable to communicate with individual cell sites 416A, 416B, 416C, 416N. As illustrated, each of the cell sites 416A-416N include an RU, DU, coupled to a CSR that is coupled to the site management component 414.

In various embodiments, the site management component 414 is configured to manage hardware and/or software deployed at each individual cell site, for example 416A, 416B, 416C, 416N. In some embodiments, the site management component 414 is configured to configure hardware on individual cell sites according to instructions provided to the site management component 414. In some embodiments, the site management component 414 is configured to boot strap network devices, upgrade network operating system (NOS), configure VLANS across the individual cell sites, and perform operations relating to C-RAN provisioning. In some embodiments, the site management component 414 is configured to connect servers or hosts via selected network topology across the individual cell sites. In some embodiments, the site management component 414 is configured to deploy virtual infrastructure management (VIM) into a workload-ready state. In some embodiments, the site management component 414 comprises a bare metal orchestrator (BMO) provided by Dell.

In various embodiments, the site management component 414 is configured to manage and/or distribute workloads and/or data to individual cell sites. In some embodiments, the site management component 414 is configured to onboard, view, and manage a virtual infrastructure across the individual cell sites. In some embodiments, the site management component 414 comprises Telco Cloud Automation (TCA) orchestrator provided by VMWare.

In various embodiments, the inventory management component 404 is configured to facilitate dynamic network inventory for one or more networks provided by the individual cell sites. In some embodiments, the inventory management component 404 provides a comprehensive, end-to-end view of the resources to plan the deployment of new infrastructure for the individual cell sites and as well as to manage capacity. This facilitates delivering dynamic services like 5G, including network slicing. In some embodiments, the inventory management component 404 is configured to provide a unified, dynamic view of hybrid resources and services across multiple domains to streamline operations and reduce complexity. In those embodiments, the inventory management component 404 provides auto-discovery and federation capabilities using graph database technology to model and visualize complex, dynamic networks, enabling automated workflows, such as the ZTP workflows. In some embodiments, the inventory management component 404 comprises a Blue Planet Inventory (BPI) system provided by Blueplanet.

In some examples, the automation management component 122 interacts directly with the inventory management component 404 to obtain configuration information associated with a component/device (e.g., an RU, DU, server, sensors, . . . ) and/or some other component (e.g., CSR, . . . ) installed at a cell site, or planned to be installed at a cell site. As discussed herein, the automation management component 122 may generate a UI 128 that can be used to define operations and automations, and select automations to perform.

In various embodiments, the workflow engine 402 is configured to facilitate ZTP operations in one or more workflows to be carried out across the cell sites and/or on a core network. The workflow may involve automating one or more jobs to set up and/or verify one or more components on the core network to be ready for deploying network functionalities on the core network. The workflow may involve setting up one or more servers on the core network and/or in the individual cell sites for cell site deployment. The workflow may involve pushing software to update one or more components in the cell sites, and/or any other operations. For example, the automation management component 122 may cause a workflow to be used to perform one or more operations at one or more of the cell sites (e.g., reboot all/portion of servers, update all/portion of the RUs/DUs, and the like at one or more cell sties 416. The workflow may also involve changing from using components provided by one vendor to another vendor. In various embodiments, the workflow engine 402 comprises a Cisco Business Process Automation Service (BPA).

In various embodiments, the workflow management component 406 is configured to manage one or more workflows to be carried out by the workflow engine 402. The workflow management by the workflow management component 406 may involve managing a workflow for updating one or more NFs, one or more servers on the core network, one or more distributed units (DU) in the core network, one or more radio access network (RAN) in the individual cell sites, one or more virtual clusters in the core network, one or more network functions in the core network, performing RAN vendor swapping, C-RAN provisioning workflows, and/or any other workflows.

In various embodiments, the network management component 406 is configured to manage one or more network components and/or devices on a core network. The network management may involve managing and identifying devices connected to the core network—for example, for the Domain Name System (DNS), Dynamic Host Configuration Protocol (DHCP), IP address management (collectively, “DDI”), and/or any other services. The network management may involve reserving and/or assigning one or more internet/intranet addresses for one or more components in the core network and/or individual cell sites. In various embodiments, the network management component comprises a system provided by Infoblox.

In various embodiments, the user interface 410 is provided to facilitate a user to monitor a progress of different operations. For example, the user interface 410 may be used to view data associated with one more update operations/tasks that the automation manager 122 causes to perform. The user interface 410 may also be used to view data associated with ZTP operations facilitated by the workflow engine 402, verify one or more results of the workflow managed by the workflow management component 406, check one or more statuses of individual cell sites, check a status of a network function on the core network, and/or any other services. In various embodiments, the user interface 410 includes a graphical user interface (GUI) depicting information available automations to perform, information about components (e.g., RUs, DUs, CSRs, . . . ) across one or more sites, a success/failure of an automation, a ZTP operation, or a workflow carried out to an individual cell sites, and/or whether or there is an issue with the automation, ZTP operation and/or the workflow.

The validation engine 412 is configured to perform one or more validation tasks for operations and/or ZTP operations facilitated by the workflow engine 402. The validation may involve validating whether one or more servers are ready on the core network for deploying individual cell sites, validating whether an NF is properly configured, validating whether an EMU is properly configured, validating whether one or more DU/RAN, or some other components are deployable before their deployment, validating operations performed during deployment, validating connections, validating operations associated with automations, and/or validating whether they are ready after their deployment.

In some examples, checks/validations are performed for workflows associated with update workflows, RU workflows, computer host provisioning (CHP) workflows, virtual server management provisioning (VSMP) workflows (e.g., VMware vCenter provisioning (VCP)), node-pool creation (NPC) workflows, distributed unit instantiation (DUI) workflows, radio access network (RAN) initiation workflows, RAN swapping workflows, C-RAN workflows, and/or other workflows For instance, for a CHP workflow, checks may be performed to ensure that data is ready for a CHP. As used herein, CHP may be referred to as provisioning a hardware server. For instance, individual CHPs available for the core network may be provided by different manufacturer such that the core network may be regarded as a hybrid cloud network. In that instance, provisioning a particular CHP may involve following provisioning procedures for that CHP as provided by a manufacturer of that CHP.

In that instance, a validation according to the provisioning procedures for that CHP may be performed as part of a Pre-CHP provisioning for that CHP. In various embodiments, this validation may involve collecting data from the workflow engine 302, the network management component 308, the site management component 314, the inventory management component 304, and/or any other components. For instance, for setting the particular CHP, information regarding the CHP should be ready in the network management component, one or more software should be ready in the inventory management component for deployment for that CHP, and/or any other checks. In some examples, when switching from one vendor to another, a different CHP provisioning workflow may be performed (e.g., provision a first type of computer host for one vendor and a second type of computer host for another vendor).

In various embodiments, different validation flows may be implemented for different operations and/or ZTP workflow. As mentioned above, in various embodiments, pre-CHP and post-CHP validation flows are implemented to facilitate CHP on the core network and/or in the individual cell sites. In various embodiments, a pre-site management component and post site management component validation flows are implemented to facilitate site management component provisioning in the example system 100. In various embodiments, a post cloud service router (CSR) validation is performed to facilitate CSR provisioning.

As used herein, a CSR may be referred to one or more components enabling routing, VPN, Firewall, High-Availability, IP SLA, AVC, WAN Opt, and/or any other network services on the core network and/or in the individual cell sites. In various embodiments, a post DU and a port RAN validation are performed to facilitate DU and RAN provisioning. In other examples, a pre-check validation, and a post-check validation can be performed to facilitate automations/configurations/provisioning.

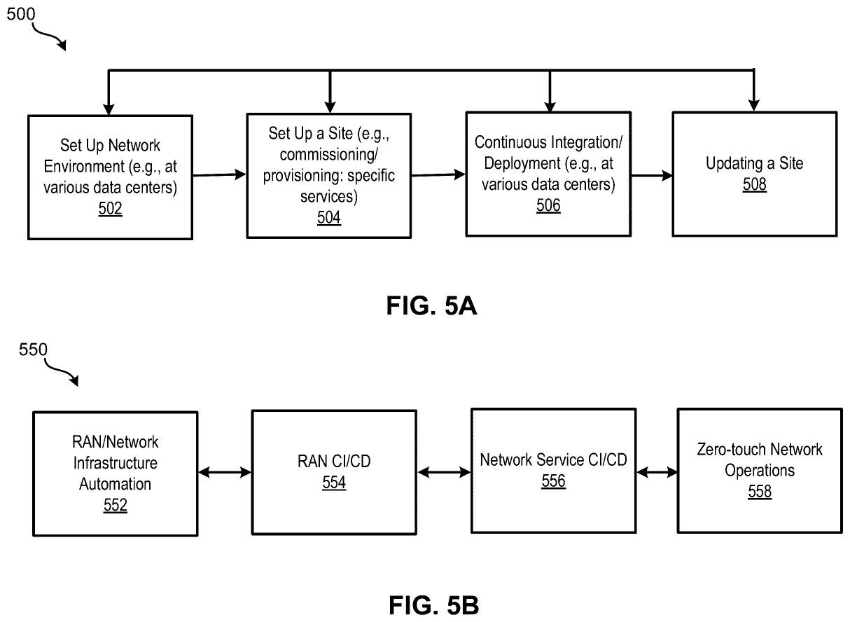

FIG. 5A illustrates an example process 500 for setting up, provisioning, and operating a O-RAN such as the example system architectures of an 5G O-RAN shown in FIGS. 1-3. In the process 500, O-RAN ZTP technologies are employed to facilitate each step in the process 500. According to some configurations, a ZTP orchestrator (ZTPO) such as workflow engine 402 and/or workflow management component 406 manages different ZTP workflows. The example process 500 is shown to help understand how the O-RAN ZTP technologies in accordance with the present disclosure helps running of an O-RAN in accordance with the present disclosure. It should be understood the steps shown in FIG. 5A, while sequential, is not intended to be limited to the specific sequence shown in FIG. 5A. In some other examples, relevant sequences for the process 500 may be different from that shown in FIG. 5A.

In some examples, the ZTPO can use various ZTP technologies in an O-RAN to 1) install/update/swap network hardware components (such as RUs, DUs) in cell sites, 2) install/update/swap network functionality components (such as EMUs, CUs, orchestrator, and/or any other networking components in the O-RAN) in data centers, and/or any other operations without someone needing to configure those components locally where they are located. For example, a new or replacement device can be sent to a cell site, physically installed and powered up by a locally present employee, who is not required to have IT skills. In some examples, the replacement devices can be from different vendors that are configured to operate in the O-RAN. This is when the ZTPO can use ZTP technologies to automatically carry out the software installation, updates, the configuration of the device, and connect the device to the O-RAN.

In the example process 500 for setting up, provisioning, and operating an O-RAN in accordance with the present disclosure, at an electronic processor, a network environment is typically set up. At 502, operations such as setting up various network function components (for example, those mentioned above) in one or more data centers is performed to facilitate the operation of the O-RAN. For example, this may involve implementing network function components according to one or more design specifications for the O-RAN, pre-CSR integration of the various network function components, emulating DUs for the O-RAN for setting up the network environment using the various network function components, implementing one or more transport tools, and/or any other operations. During this stage, a ZTP layer can be implemented, for example such as the O-RAN ZTP layer shown in FIG. 2.

At 504, a cell site can be set up in the network environment set up at 502. For example, in the 5G context shown in FIG. 2, this may involve installing one or more RUs in the cell site, laying cables in the cell site, configurating one or more CSRs for the cell sites, making connections from the RUs to the CSRs, making connections from the cell site to a core network in the network environment, making connections between the cell site and any other cell sites, and/or any other operations. In some examples, an EMU can be installed in the cell site, the EMU can be connected to the CSR, and the like. During this stage, functions or services can be automatically provisioned or commissioned on various components.

For instance, after a DU is installed and powered up for the first time, a communication address can be automatically assigned to the DU device. Then, a component in the O-RAN ZTP layer can automatically configure the DU device through the communication address assigned to the DU device. For example, the component can connect to a CSR at a site that is connected to the DU and can obtain the assigned communication address, obtain the MAC address (e.g., from the DU and/or from the inventory management 404 component), determine a current software version for the DU, determine whether to update the current DU software to a new version, reboot the DU, perform one or more health checks for the DU, and update data associated with the DU within one or more components, such as within inventory management component 404. The validation component may also connect with other components to determine actual configuration data of the components.

As another example, after an RU device is installed in the cell site (such as cell site 202a or 202b shown in FIG. 2) and powered up for the first time, a communication address can be automatically assigned to the RU device. Then, a component in the O-RAN ZTP layer can automatically configure the RU device through the communication address assigned to the RU device. For example, the component can connect to a CSR at a site that is connected to the RU and can obtain the assigned communication address, obtain the MAC address (e.g., from the RU and/or from the inventory management 404 component), determine a current software version for the RU, determine whether to update the current RU software to a new version, reboot the RU, perform one or more health checks for the RU, and update data associated with the RU within one or more components, such as within inventory management component 404. The validation component may also connect with other components to determine actual configuration data of the components. As another example, a CSR implemented in the cell site can be automatically integrated into the network environment according to a network specification configured with the O-RAN ZTP layer after the CSR is ready to function in the network environment.

A validation component, such as validation engine 412, may also perform one or more other checks to determine information about installed components (e.g., configuration data), whether the installed components of the cell site are operating correctly, and the like. For example, a validation component may obtain planned configuration data from the inventory management component 404, and from one or more other components (e.g., network management component 408, site management component 414) as well as directly from an installed component.

At 506, continuous integration and continuous deployment (CI/CD) of various network function components are carried out in the network environment set up at 502. CI/CD is a set of practices that enable how software, in this case, O-RAN software, is installed and updated. CI or Continuous Integration is the practice of merging all developers working code to a shared mainline several times at a frequency. Every merge is typically validated before merging to uncover any issues. CD or Continuous Delivery/Deployment is the practice in which software developers produce reliable software in short cycles that can be released (delivered) at any time, which can then be deployed at a frequency. As a result, any software can be released much faster, more frequently and reliably into O-RAN. The benefit of CD is more predictable deployments that can happen on demand without waiting for an “official” upgrade cycle—this is now thing of the past.

Examples of CI/CD at 506 can include infrastructure deployment or update including the following components: networking stack, computing stack, storage stack, monitoring stack, security stack, core network functions. In some embodiments, the CI/CD at 506 can include Cloud-Native Network Functions (CNF) deployment and update. For instance, a CNF is deployed onto one or more CUs using control tools. In some embodiments, the CI/CD at 506 can include deploying a specific application or tool for a specific CNF. In some embodiments, changes to various network function components are deployed in the network environment continuously. In implementations, a ZTP workflow is used to facilitate the aforementioned CI/CD operations. In some configurations, the ZTP workflow is deployed within the O-RAN ZTP layer shown in FIG. 2. In that implementation, the ZTP workflow defines various stages through which software code is retrieved from a source code repository, is built into corresponding artifacts (e.g., micro-services, network functions), is tested using predefine tests, and is deployed in the network environment after successful results of the testing.

At 508, a cell site is updated, for example, with latest software or configuration. This may be triggered at a preset frequency configured at the ZTP layer in the network environment. For instance, a cadence such as every week may be set to update software deployed on the components in the cell site, such as RUs, DUs, CSRs, and/or any other components. In some examples, the automation manager 122 is configured to perform validation check tasks is configured to run on a predetermined schedule and/or in response to some other condition. Running the validations helps to ensure that NFs, and/or other components installed at a cell site are operating correctly.

Operations at 508 can also involve configuring or provisioning devices or components newly installed in the cell site—e.g., replacement or new devices. In some examples, the operations at 508 can involve swapping one or devices or components provided by one vendor to devices or components provided by another vendor. Similar to operations at 504, in such situations, software can be pushed to the newly installed devices or components by the ZTP layer once they are live in the network environment.

In implementations, operations involved in 504 may be referred to as “day 0” operations. Operations involved in 502 may be referred to as “day 1” operations. Operations involved in 506 may be referred to as “day 2” operations. Operations involved in 508 may be referred to as “day 3” operations. The numerical references in these operations do not necessarily indicate that these operations have to happen in a time sequence. As shown in FIG. 5A, operations in the example process 500 can happen in any sequence. For example, after a day “0” operation in 504 happens, the process 500 can proceed to 502 to push a specific configuration that involves components in the “day 0” operation to a core network (such as the 5G core 208 shown in FIG. 2), and then proceed to 508 to update another cell site (e.g., to configure that cell site to be connected to the cell site set up in the day 0 operation). Other scenarios are contemplated. According to some examples, the workflow engine 502 can orchestrate deployment of cell sites in parallel. For instance, the workflow engine 502 may coordinate the ZTPO workflows for the deployment of two, three, ten, a hundred cell sites, and the like at the same time.

FIG. 5B illustrates another example process 550 showing an example of how ZTP and CI/CD are facilitated in an O-RAN in accordance with the present disclosure. Process 550 illustrates the ZTP and CI/CD in the O-RAN in accordance with the present disclosure from a perspective of O-RAN operation cycles.

At 552, an activity or operation at a cell site triggers an automation in the ZTP layer of the O-RAN. For example, this may involve performing an automation in one or more cell sites. Once a component/device is online, an automation can be performed that performs one or more operations (e.g., a software update, installing a security patch, configuring the component/device, and the like). In some embodiments, the ZTPO in the ZTP layer may be configured to monitor activities across cell sites in the network environment and the automation is triggered by the ZTPO once the replacement device is detected to be online.

At 554, lower-level network (e.g., radio network or RAN) CI/CD can be carried out. In some situations, the operations in 554 are triggered by one or more activities at 552. For example, as illustration, after a replacement RU device is brought online and configured by the ZTP layer in the O-RAN, one or more components in a CSR, DU and/or CU is to be configured to record the replacement RU device. In that example, the ZTP layer in the O-RAN can trigger such a configuration so the lower-level network is updated to incorporate the replacement RU into the O-RAN. In some situations, the lower-level network CI/CD at 554 is independent of the activities at cell sites. For instance, the software developers for particular types of CSR, DU or CU can set a CI/CD pipeline and schedule deployment of their latest software on the CSR, DU or CU at a preset frequency (e.g., nightly or weekly).

At 556, network service CI/CD is performed. In some situations, the CI/CD operations in 556 are triggered by one or more operations or changes in at 554. For example, as illustration, after software is deployed at the lower network level at 554, one or more network services are updated based on the deployment of the software. For instance, without limitation, in the context of 5G, various 5G network services can be updated after the underlying RAN in the 5G O-RAN are updated. In some situations, the CI/CD operations in 556 are independent of operations or changes at 554. For example, software developers of the core network services for the 5G O-RAN can set up a schedule to release their software to update the core network services on a regular basis.

At 558, operations control the ZTP in the O-RAN are performed. Examples of these operations can include scheduling release of software to update O-RAN components, instantiating a DU or CU, provisioning an RU or CSR in a cell site, performing a vendor RAN swap, and/or any other operations. In some examples, the operations at 558 are performed using a NOC such as the NOC 210 shown in FIG. 2. It should be understood although process 550 is illustrated so far from 552 to 558 in sequence, this is not intended to limit the O-RAN ZTP technologies in accordance with the present disclosure to a bottom up or top-down approach. In a top-down approach, ZTP is instigated, for example, at 558 and software is pushed to the core network, lower network level, and/or cell sites through the workflow engine 402 in the ZTP layer in the O-RAN. In a bottom-up approach, ZTP request is generated, for example, by a component at a cell site or data center, and software is pushed to that component through the workflow engine 302 in the ZTP layer in the O-RAN. In various embodiments, a ZTP request is configured for instigating one or more ZTP operations in the O-RAN.

In some situations, ZTP can be carried out by a third-party vendor to update its components in the O-RAN in a mixture of bottom-up and top-down approach. For instance, the third-party vendor may ship a router device to a cell site, which is installed by a technician on the cell site. Once the router device is live, it generates its status information to a management server of the third-party vendor for configuration of the router. In that example, the third-party vendor dynamically configures the router according to specifications or requirements of the O-RAN where the router is installed. In this way, a mixture of bottom-up and top-down ZTP is used to configure the router.

### Example C-RAN System

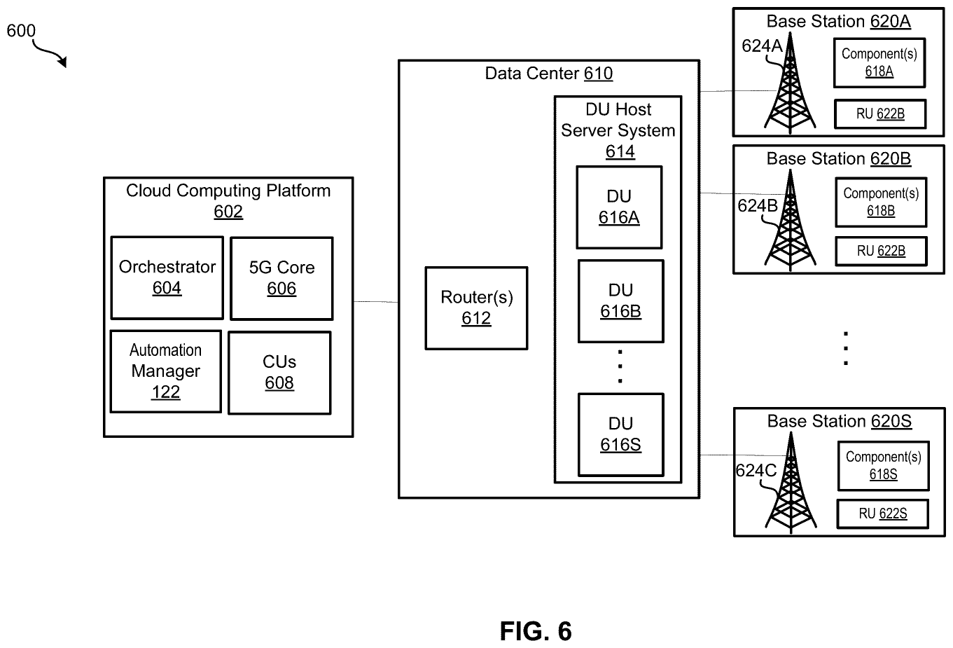

FIG. 6 illustrates an example of cellular network system 600 that depicts a C-RAN, in accordance with aspects of the invention. As illustrated, system 600 can include: cloud computing platform 602: data center 610; and base stations 620 (which may be referred to as a cell site). In system 600, base stations 620, includes structures 624, components 618, and radio units 622. In the C-RAN system 600, the DUs 616 are implemented remotely at a geographically separated data center 610.

Data center 610 can serve to host DU host server system 614, which can host multiple DUs 616 which are remote from corresponding base stations 620. For example, DU 616A can perform the DU functionality for base station 620A, DU 616B can perform the DU functionality for base station 620B, DU 616S can perform the DU functionality for base station 620S, and the like. In other examples, the association of a DU 616 with a RU in a base station can be changed. For instance, an association may change in response to some event/condition (e.g., a new DU is provisioned within the DU host server system 614. In some examples, the DU host system 614 may be referred to as a BBU hotel. DUs with DU host server system 614 can communicate with each other as needed.

According to some examples, the data center 610 may comprise one or more local data centers (LDCs) and/or one or more edge data centers (EDCs). Data center 610 can include multiple routers, such as routers 610, and can serve as a hub for base stations 620. In a cloud-computing cellular network implementation at least some components, such as CUs 608 and functions of 5G core 606, may be hosted on cloud computing platform 602 where higher-level functions of CU 608 and 5G core 606 can be executed in the cloud. In other embodiments, CU 608 and 5G core 606 may be hosted using hardware maintained by the cellular network provider, which may be in the same or a different data center from data center 610. While CUs 608 are illustrated within cloud computing platform 602, some/all of the CUs 608 may be located at a different location, such as at data center 610.

In some examples, encoded radio data is transmitted (e.g., via fiber optic connections 340 between BSs 620 and data center 610. According to some configurations, the connections between BSs 620 and data center 610 can be dedicated point-to-point communication links or a network on which addressing is used. Multiprotocol label switching (MPLS) segment routing (SR) may be used to perform routing over a network (e.g., fiber optic network). Such segment routing can allow for network nodes to steer packetized data based on a list of instructions carried in the packet header. This arrangement allows for the source from where the packet originated to define a route through one or more nodes that will be taken to cause the packet to arrive at its destination. Use of SR can help ensure network performance guarantees and can allow for network resources to be efficiently used. While MPLS SR can be used for network connections, it should be understood that other protocols and non-fiber-based networks can be used for connections between BSs 620 and data center 610. Real-world implementations of system 600 can include many (e.g., thousands) of BSs, and many DUs and CUs. BSs can include one or more antennas that allow RUs to communicate wirelessly with UEs (not shown). RUs can represent an edge of cellular network where data is transitioned to RF for wireless communication. The radio access technology (RAT) used by an RU may be 5G NR, or some other RAT.

In contrast to traditional cell-based network infrastructures that includes centralized processing, C-RAN breaks the base station into different parts. The RUs 622 are part of the BS 620, but the DUs 616 are aggregated at a central location (e.g., within a DU host server system 614). Moving the DUs 616 to data center 610 help a provider manage these functions provided by the DUs. Centralizing the DUs provides advantages, such as ease of maintenance, resource virtualization, higher processing power, joint processing, radio sharing, increased data security, less power consumption, scalability, and the like. In some examples, one or more of the CUs may be co-located with one or more of the DUs 616 or hosted at a different data center. The actual split between DUs and RUs may be different depending on the specific use-case and implementation.

As illustrated, the DUs 616 can be shared by the different base stations 620. According to some configurations, pooling the DUs can reduce the number of DUs needed compared to traditional architectures. Additionally, the cost of network operation can be reduced since energy consumption is reduced compared to the traditional RAN architecture. DUs 614 within DU host server system 614 can also be added, upgraded, and removed more easily, thereby improving scalability and easing network maintenance.

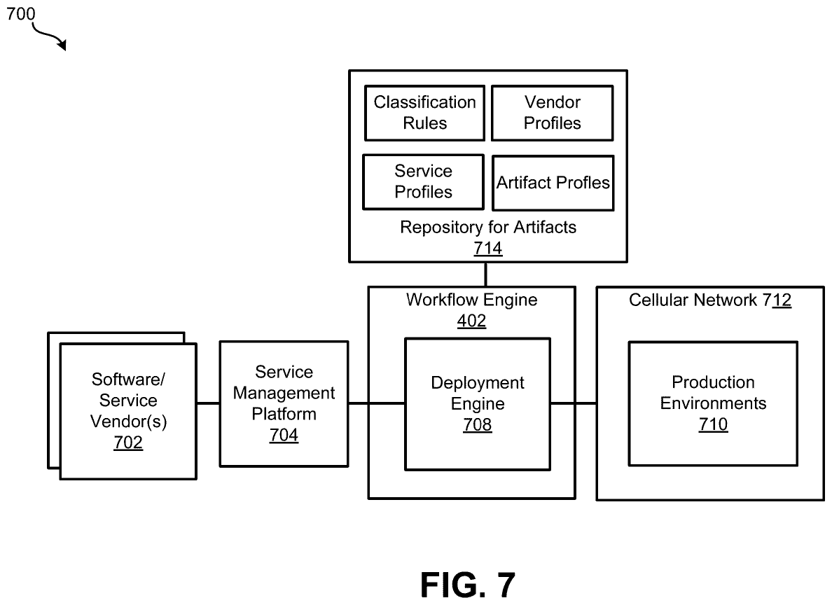

FIG. 7 illustrates an example of a communications system 700 for deploying software from different vendors within a cellular network, according to various embodiments. In the illustrated example, the system 700 includes, among other components, multiple software/application/service vendors 702 (hereinafter “vendors 702”), a service management platform 704, a workflow engine 402 that includes a deployment engine 708, one or more production environments 710 established on a production cellular network, and one or more repositories (e.g., a repository for artifacts 714). Additional or alternative components may be included in the system 700. Various components of the system 700 are in communication with each other for data transmission.

In some embodiments, the service vendors 702 may be third-party service providers that provide physical devices and/or software/applications/services to be used within a production environment 710 (e.g., one or more cell sites). In some cases, the vendors can employ Continuous Integration and Continuous Deployment (CI/CD) methodologies. As a brief example, developers of a service vendor 702 may use a version control system to manage source codes of the new application or service, set up repositories and branches to enable code versioning, and configure a selected CI tool to automatically trigger builds when code changes are pushed to the repository.

IBuild scripts or configuration files (e.g., YAML) can be generated and defined to specify the required build steps, dependencies, and environment configurations. Unit tests are incorporated into the CI pipeline to verify the correctness and functionality of individual components or units within the new application or new service. Static code analysis tools may be used to analyze code quality, identify potential issues, and enforce coding standards. Once the new application or new service is built, the complied code and any required dependencies may be packaged into an artifact in a deployable format. A version number may be assigned to the generated artifact. Relevant metadata and documentation may be included in the artifact. The metadata may include details like the artifact name, version, release notes, licensing information, authorship, and any other pertinent information that helps consumers of the artifact understand its purpose, usage, and deployment. In some embodiments, the artifact generation process may be automated within the CI/CD pipeline. After successfully building and packaging the new application or new service, the artifact can be automatically generated and versioned.

Generally, an artifact refers to a packaged and versioned software component or set of files that are ready for deployment to a target environment, such as to one or more production environments 710 within a cellular network 712, and contains the necessary files, configurations, dependencies, and any other resources required to execute the software application or service in the target environment. The artifact may take various forms such as binary packages, archive files, container images (Docker images or images), configuration files, database scripts, and so on. The images encapsulate the application code, dependencies, and configurations in a portable and self-contained unit that can be deployed and run on container platforms. In some embodiments, a service may include multiple artifacts, and each artifact within the application service may contribute to a certain functionality of the application service. In some embodiments, the application service provided by the service vendor is a Software as a Service (SaaS) application.

The service management platform 704 can act as an intermediary between the vendors 702 and the deployment engine 708. The service management platform 704 is configured to receive to-be-deployed services and artifacts associated with the services from the service vendors 702, push the received services and artifacts to the workflow engine 402, and facilitate communication, integration, and control over the services provided by the service vendors 702. In some embodiments, the service management platform 704 is an Application Programming Interface (API) management platform, such as Google Cloud Platform (Apigee), Azure API Management, etc.

Within the workflow engine 402, the deployment engine 708 is responsible for receiving and responding to requests to deploy artifacts within a production environment 710. As discussed briefly above, the request may be a request to install, modify, and/or swap out an already installed artifact that was provided by a different vendor. In some cases, the artifacts are tested within a test environment using a testing system (not shown) prior to deployment within the production environment 710. The test environment can provide the necessary infrastructure, resources, and configurations to simulate the production environment 710.

According to some configurations, the workflow engine 402, and/or the deployment engine 708 accesses the repository for artifacts 714. The repository 714 can be an artifactory and act as a centralized location for storing and managing the validated/trusted services and their associated artifacts. The repository 714 may facilitate version control, access control, and easy retrieval of the validated/trusted services. The automated deployment system 706 is further configured to push the validated/trusted services to the production environments 710 of the cellular network 712 for deployment of the validated/trusted services in the production environments 710. The tested and validated services can be made available to users/clients on the production cellular network. The repository 714 can store various data such as, but not limited to classification rules, vendor profiles, service profile, artifact profiles, inventory of class identifiers, and so on.

In some embodiments, the deployment engine 708 is executed on a virtual private cloud (VPC) of the cloud-computing platform. A VPC provides a logically isolated section of the cloud infrastructure where the automated deployment engine 708 can operate. The deployment engine 708 can take advantage of the virtualization, on-demand resource provisioning, and network isolation provided by the VPC to allow for testing and deployment activities in a flexible and scalable environment.

The streamlined process with deployment of artifacts by the automated deployment engine 708 provides advantages with respect to efficiency, scalability, accuracy, and reliability. The automated deployment engine 708 can streamline the overall deployment workflow, eliminate manual steps, and reduce errors and inconsistencies. The deployment engine 708 in communication with the workflow engine 402 can handle the management and deployment of a large volumes of artifacts within different production environments 610.

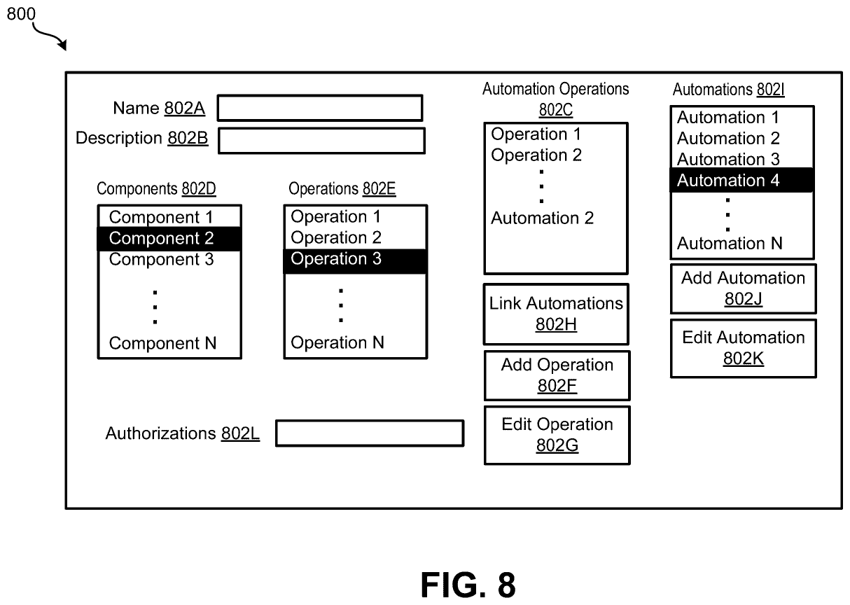

FIG. 8 is a diagram illustrating an example user interface 800 for defining an automation, according to various embodiments. In some configurations, the UI 800 is caused to be displayed by the automation manager 122 and includes UI elements 802. In the UI 800 illustrated in FIG. 8, the UI elements 802 include a name UI element 802A, a description UI element 802B, automation operations UI elements 802C, components UI elements 802D, operations UI elements 802E, add operation UI element 802F, edit operation UI element 802G, automations UI elements 802I, add automation UI element 802J, edit automation UI element 802K, and authorizations UI element 802L. Depending on the implementation, the UI 800 may include additional, fewer, or alternative UI elements 802 and/or functionality.

According to some configurations, a user can use the UI elements 802 to define an automation. In other examples, a user can use some other type of user interface (UI) (e.g., using voice input, command line input, . . . ) to define an automation and/or help to define an automation. As an example, a user may select to create an automation to upgrade an RU and to perform a RU restart. The RU upgrade and restart automation could be to restart any brand of RU that may be deployed at a cell site.

The name UI element 802A can be used to specify the name of an automation. The description UI element 802B can be used to specify a description of the automation being defined (e.g., RU upgrade, DU restart, Obtain Health Sensor data, . . . ). To add a new automation, a user may select the add automation UI element 802J. To edit an existing automation, a user may select the edit automation UI element 802K. For instance, the user may select an automation (e.g., as illustrated by Automation 4) from automations UI element 802I and then select the edit automation 802K to make changes to one or more operations of the automation.

In some examples, in response to selection of an automation, the operations/automations associated with the selected automation are illustrated within automation operations UI element 802C. To add a new operation, a user may select the add automation UI element 802J. To edit an existing automation, a user may select the edit automation UI element 802K. For instance, the user may select an automation (e.g., as illustrated by Automation 4) from automations UI element 802I and then select the edit automation 802K to make changes to one or more operations of the automation.

In some examples, a user may select a component within the components 802D to determine what components are deployed within the cellular networks. For example, a user may select a component, such as component 2 within the components UI element 802D to view the operations (e.g., within the operations UI element 802E) that are available to perform on a component. In some configurations, the operations included within the operations UI element 802E are based on the functionality available to be accessed (e.g., using an API and/or some other method).

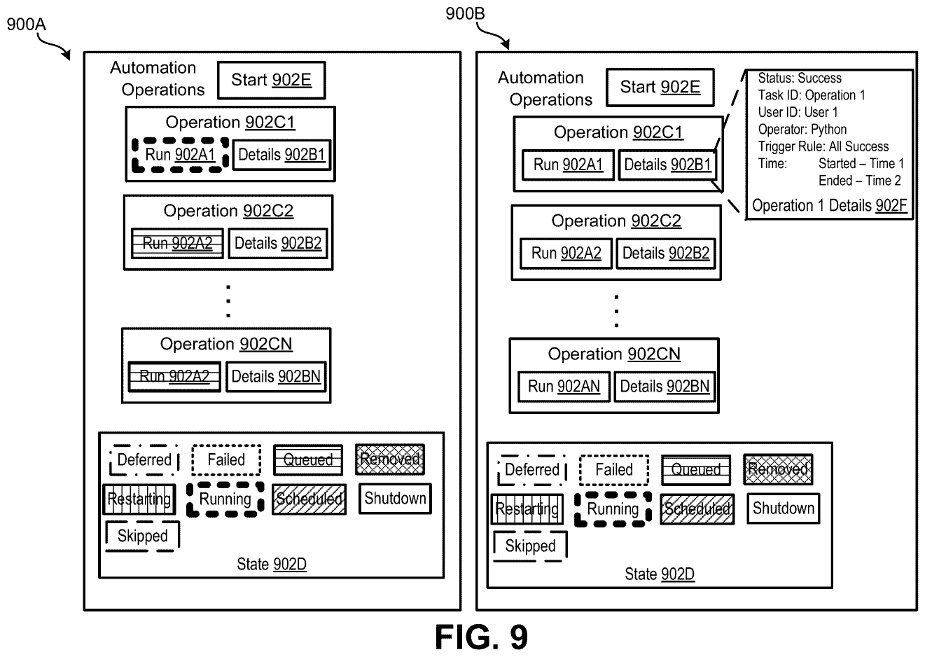

FIG. 9 is a diagram illustrating example user interfaces 900 for viewing data about operations of an automation, according to various embodiments. In some configurations, the UI 900 is caused to be displayed by the automation manager 122 and includes UI elements 902. In the UI 900 illustrated in FIG. 9, the UI elements 902 include operation UI element 902C(1-N), run UI elements 902A(1-N), details UI elements 902B(1-N), and a state UI element 902D. Depending on the implementation, the UI 900 may include additional, fewer, or alternative UI elements 802 and/or functionality.

In some examples, a user may select an automation (e.g., using UI 800 and/or some other selection mechanism) to view information about the automation as it is being executed. In the current example, a user has selected the start UI element 902E which caused the automation manager 122 to start performing the operations of the automation. In response to starting operation 902C1 the run UI element 902A1 is changed (e.g., bolded dashed line around the run UI element 902A1) to indicate that the operation 902C1 is running. The other run UI elements 902A2-902AN are changed (e.g., dashed lines) to indicate that the operations 902C2-902CN are queued and pending execution. The run UI elements 902A can be changed to indicate a different state as indicated within state UI element 902D.

A user may also select a details UI element 902B, such as 902B1 to obtain more detailed information about the execution of the operation. For example, referring to UI 900B it can be seen that after selecting details UI element 902B1, details UI element 902F is displayed that indicates information about the execution of the operation 902C1.

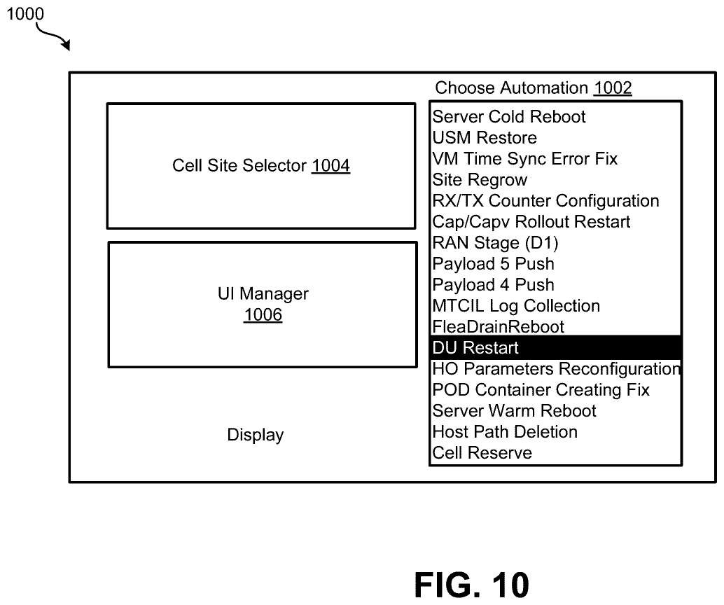

FIG. 10 is a diagram illustrating an example user interface 1000 for selecting and performing an automation at one or more cell sites, according to various embodiments. In some configurations, the UI 1000 is caused to be displayed by the automation manager 122. Depending on the implementation, the UI 1000 may include additional, fewer, or alternative UI elements and/or functionality.

According to some configurations, a user may select an available automation from a graphical user interface (GUI), such as UI 1000, or some other type of user interface (UI) (e.g., using voice input, command line input, . . . ). For example, a user may select to perform a DU restart (as illustrated by the selectin within choose automation UI element 1002 at one or more cell sites. The DU restart automation could be to restart any brand of DU that may be deployed at a cell site. In some configurations, an automation, such as the DU restart automation may determine the type/brand of DUs deployed at a cell site, or some other location, and select the automation to perform to restart the DU based on the brand. If more than one type of DU is deployed at a cell site, the automation manager 122 may select a first automation to perform for the first type of DUs, and select a second automation to perform for a second type of DU. Similarly, the automation manager 122 may perform different automations at different cell sites based on the brand/type of component (e.g., RU) deployed at each of the cell sites.

In some examples, the automation manager 122 determines the automations to display within UI 1000 based on automation(s) that the user is authorized to perform. For example, a first user may be authorized to perform all operations, whereas a second user may be authorized to perform a portion of the available automations. For instance, a user may be authorized to select an automation to reboot a server, whereas a second user may not be authorized to reboot a server.

A user may also specify where to perform the automation (e.g., at a single cell site or a group of cell sites). In some examples, a user may select the cell site selector UI element 1004 to specify the cell site, or cell sites to perform the automation. For instance, a user may specify and/or select a single cell site identifier or may identify more than one cell site to connect to and perform the operations. As an example, a user may specify to reboot one or more servers at one or more cell sites, update all of the DUs 104 that are associated with a particular vendor or multiple vendors, perform one or more operations that affect a single device/component, perform one or more operations that affect many different devices/components, and the like.

According to some configurations, a UI manager 1006 may include UI elements (not shown) that allow a user to view data associated with one or more components/devices deployed at one or more cell sites 102, and/or provide data (e.g., parameters, settings, configuration information, . . . ) to one or more components/devices deployed at one or more cell sites 102. For example, the UI manager 1006 may provide a UI that includes a view of health data associated with one or more cell sites.

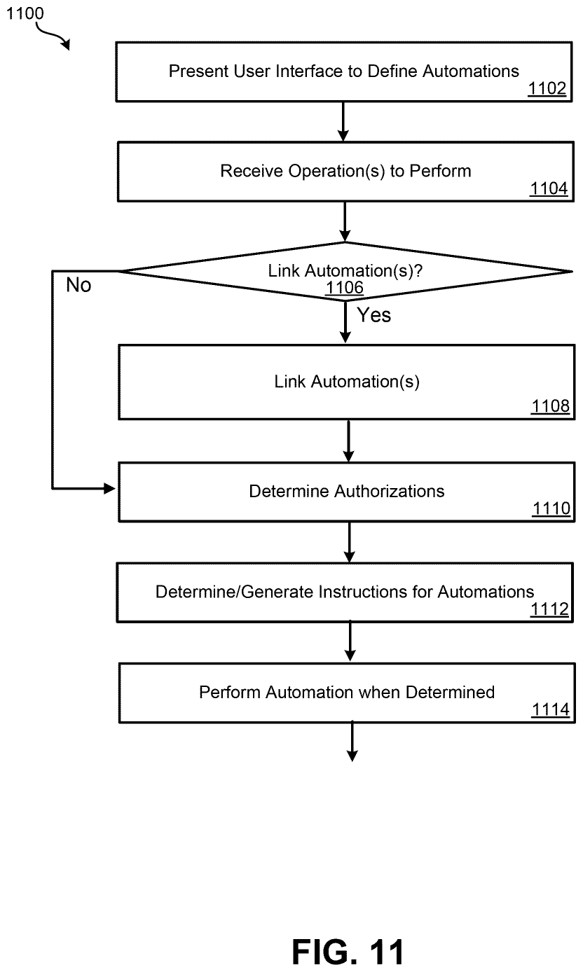

FIG. 11 is a flow diagram illustrating an example method 1100 for defining one or more automations, according to various embodiments. The method 1100 may be implemented by one or more components included in the systems described herein. In some configurations, the method 1100 is implemented by automation manager 122. Depending on the implementation, the method 1100 may include additional, fewer, or alternative steps performed in various orders or in parallel.

At 1102, a user interface is displayed. In some examples, the user interface 128 includes user interface elements that allow a user to define and specify operations to include within an automation. According to some examples, the UI includes UI elements that can be used to select components/operations/other automations to include within the automation, as well as UI elements to specify authorizations as to what user(s) can perform the automations, as well as UI elements to edit operations.

At 1104, one or more operations to include within an automation are received. In some examples, the operations to include within an automation are received from a user using a UI, such as UI 800. According to some configurations, the request is received by an automation manager 122 associated with a NOC 210. In some configurations, the operations relate to RUs, DUs, CUs, or other components deployed at one or more cell sites and/or at other locations within the cellular network.

At 1106, a determination is made as to whether one or more automations are to be linked with another automation. When there is one or more other automations to link with the automation, the process moves to 1108. When there is not another automation to link with the automation, the process moves to 1110.

At 1108, the one or more automations to link are linked. As discussed above, a linked automation may be configured to be performed before execution of the other operations of the automation, after the execution of the operations of the automation, or at some other point within the operations of the automation. In some examples, the user specifies the ordering of the operations and the one or more linked automations. In other examples, the one or more automations can automatically be linked by the automation (e.g., based on a type of automation). For instance, a health check automation may be linked by the automation manager before the other operations and/or after the performance of the operations.

At 1110, the authorizations are determined. As discussed above, an authorized user may specify the user(s)/group(s) that are authorized to perform an automation. In some examples, the authorized user specifies the user(s)/group(s) that are authorized to perform an automation using a UI. In other examples, the authorized user specifies the user(s)/group(s) that are authorized to perform an automation by configuring an authorizations file.

At 1112, the instructions for the automation are generated/determined. As discussed above, in some examples, different instructions are generated for each of the different brands of components that are included within an automation. In some examples, the instructions may be programmed by a user, supplied by a vendor, and/or obtained from some other source.

In some examples, the operations associated with an automation may be preconfigured for a particular brand of a component/device (e.g., a script, a workflow, . . . ). In other examples, a user may enter the operations/automations to perform using a user interface by selecting one or more user interface elements and/or entering information using some other mechanism (e.g., text or voice). As discussed above, the one or more automation may be related to one or more of the components/devices installed at the cell site. In some examples, the automation manager 122 is configured to perform a health check operation for one or more components/devices performed before performing an automation. The automation manager 122 may also include other operations/automations with a selected automation, such as one or more update automations, a restart automation, and/or some other automation. In some examples, a health check operation performed after performing the automation and/or data validation operations can be included in the operations of an automation. In some examples, the automation manager may communicate with the inventory management system 404, to identify what brands of components are deployed within the cellular network.

At 1114, an automation is performed when determined. As discussed above, an automation can be performed at many different cell sites. For example, the one or more automations may specify to perform an update of all DUs that are a particular brand. In this example, the automation manager 122 may access data 126 to identify the components/devices 118 that are the specified brand and determine the cell sites where the identified components/devices are located.

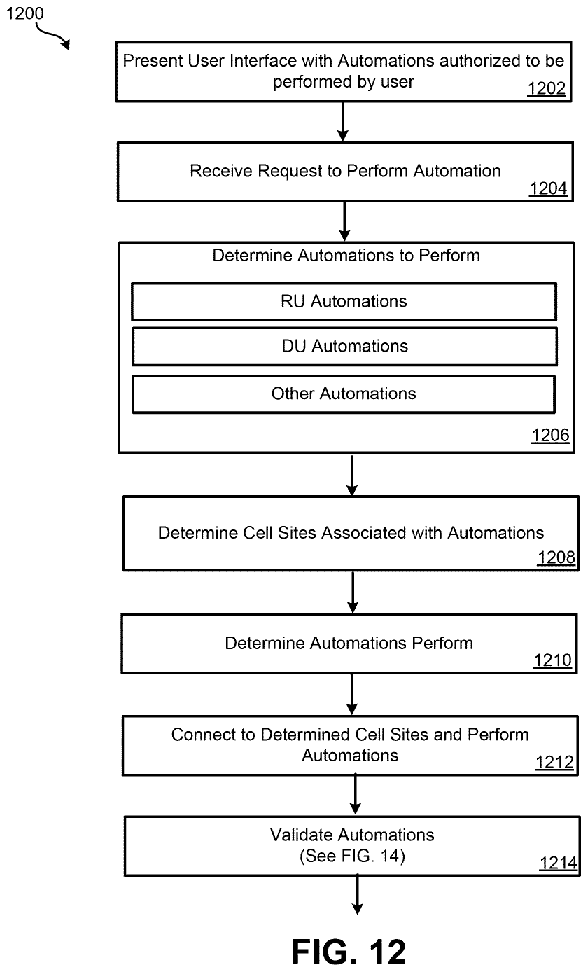

FIG. 12 is a flow diagram illustrating an example method 1200 for performing one or more automations at one or more cell sites, according to various embodiments. The method 1200 may be implemented by one or more components included in the systems described herein. In some configurations, the method 1200 is implemented by automation manager 122. Depending on the implementation, the method 1200 may include additional, fewer, or alternative steps performed in various orders or in parallel.

At 1202, a user interface is displayed. In some examples, the user interface 128 includes a list of automations that the user is authorized to perform. See description above.

At 1204, a request to perform an automation is received. In some examples, a request is received from a user using a UI, such as UI 800. According to some configurations, the request is received by an automation manager 122 associated with a NOC 210. In other examples, the automation manager 122 is automatically triggered (e.g., by the workflow engine 402) based on an occurrence of one or more events, and/or according to a schedule.

At 1206, one or more automations to perform are determined. In some examples, the automations include operations relating to RUs, operations relating to DUs, and/or operations relating to other components/devices at one or more cell sites 102.

At 1208, the cell sites associated with the automation request are determined. In some examples, a request is received from NOC 210 to perform one or more automation operations. In other examples, the automation manager 122 is automatically triggered (e.g., by the workflow engine 402) based on an occurrence of one or more events and/or according to a schedule. See FIG. 10 and related discussion for further information.

At 1210, the automation to perform are determined. In some examples, the operations associated with an automation may be preconfigured for a particular brand of a component/device (e.g., a script, a workflow, . . . ). In other examples, a user may enter the operations/automations to perform using a user interface by selecting one or more user interface elements and/or entering information using some other mechanism (e.g., text or voice). As discussed above, the one or more automation may be related to one or more of the components/devices installed at the cell site. In some examples, the automation manager 122 is configured to perform a health check operation for one or more components/devices performed before performing an automation. The automation manager 122 may also include other operations/automations with a selected automation, such as one or more update automations, a restart automation, and/or some other automation. In some examples, a health check operation performed after performing the automation and/or data validation operations can be included in the operations of an automation.

In some examples, the workflow engine 402 may communicate with the workflow management component 406, and/or the inventory management system 404, and/or the automation manager 122 to identify the workflows/operations to perform. For instance, the workflow engine 402 may access vendor profiles from repository 614 to identify the workflows to deploy hardware/software associated with a vendor. In some cases, different workflows can be associated with the different vendors. In this way, the workflow engine 402 can access and orchestrate the execution of the workflows for that vendor and/or the type of operation desired to perform. In other examples, the EMS operations to perform may be obtained from a GUI, such as associated with NOC 210.

The one or more automation operations can be performed at many different cell sites. For example, the one or more automations may specify to perform an update of all DUs that are a particular brand. In this example, the automation manager 122 may access data 126 to identify the components/devices 118 that are the specified brand and determine the cell sites where the identified components/devices are located.

At 1212, the automation manager 122 connects to the determined cell sites and performs the determined operations to perform the automation. In some examples, the automation manager 122 establishes a connection with the CSRs at the determined cell sites. In other examples, the automation manager 122 may establish a connection with one or more installed components at a cell site, the network management component 408, the validation engine component 412, the workflow engine 402, and the like. After connecting to a cell site, the automation operations are performed. As discussed above, the automation manager 122 may directly communicate with NFs 118 to cause the update to be performed.

At 1214, one or more validation operations are performed. As discussed above, the automation manager 122 may directly communicate with one or more components, such as inventory management component 404, an installed component at a cell site, and/or other components discussed herein to perform one or more operations that validate the execution of the one or more update operations. See FIG. 10 and related discussion for more details.

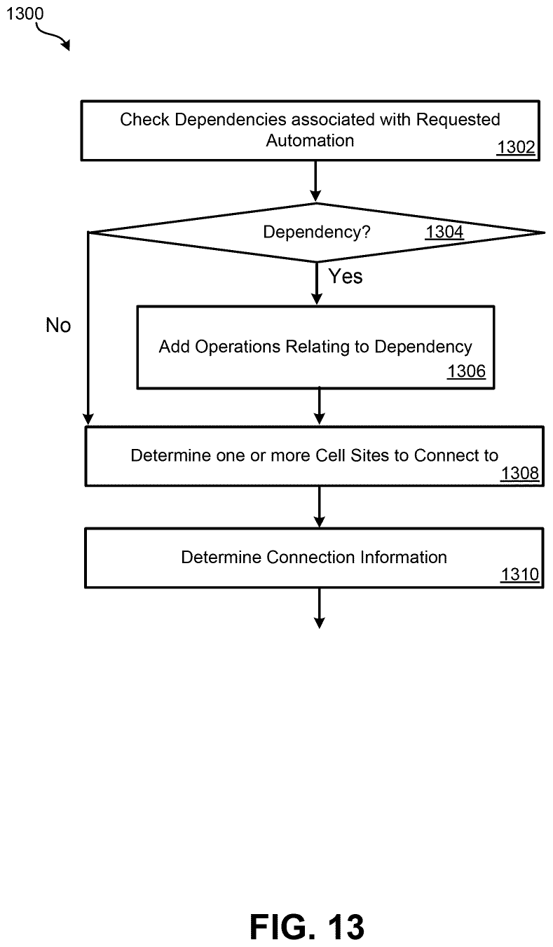

FIG. 13 is a flow diagram illustrating an example method 1300 for determining what cell sites to connect to and what network functions to update, according to various embodiments. The method 1300 may be implemented by one or more components, such as automation manager 122, included in the systems described herein. Depending on the implementation, the method 1200 may include additional, fewer, or alternative steps performed in various orders or in parallel.

At 1302, dependencies associated with the requested automation are determined. As discussed above, the automation selected may include one or more operations that are dependent upon some other component/device/condition.

At 1304, a determination is made as to whether there is a dependency with the requested automation. As discussed above, in some examples, the automation manager 122 may check dependencies to identify if one or more other operations are to be performed before/after performing the operations the automation. For example, one brand of DU may specify to update the associated RU before updating the DU. When there is a dependency, the method 1300 moves to 1306. When there is not a dependency, the method moves to 1308.

At 1306, the operations relating to the dependency are added to the automation operations. As discussed above, the automation manager 122 may access data 126 to determine the operations to perform for an automation.

At 1308, one or more cell sites 102 to connect to are determined. As discussed above, the cell sites to connect to can be based on a site, or sites specified within a request. For example, a user may enter a site ID (e.g., site 10), or a plurality of site IDs (e.g., sites 1-1000). In other examples, the cell sites can be determined by parsing the request. As briefly described above, the request may specify to perform an automation associated with a DU, or some other component (e.g., RU, CSU, . . . ). In some examples, the request may specify to update all DUs deployed (e.g., regardless of brand), a brand of DUs to update, and the like.

At 1310, connection information for the components/devices at the one or more cell sites 102 is determined. As discussed above, the automation manager 122 can access a component, such as an inventory management component 404, a network management component 408, a site management component 414, the data 126, or some other device/component to determine the IP address information. In some examples, the automation manager 122 obtains IP address information associated with the CSR router(s) and/or the components/devices to update within the determined cell sites 102 can be obtained.

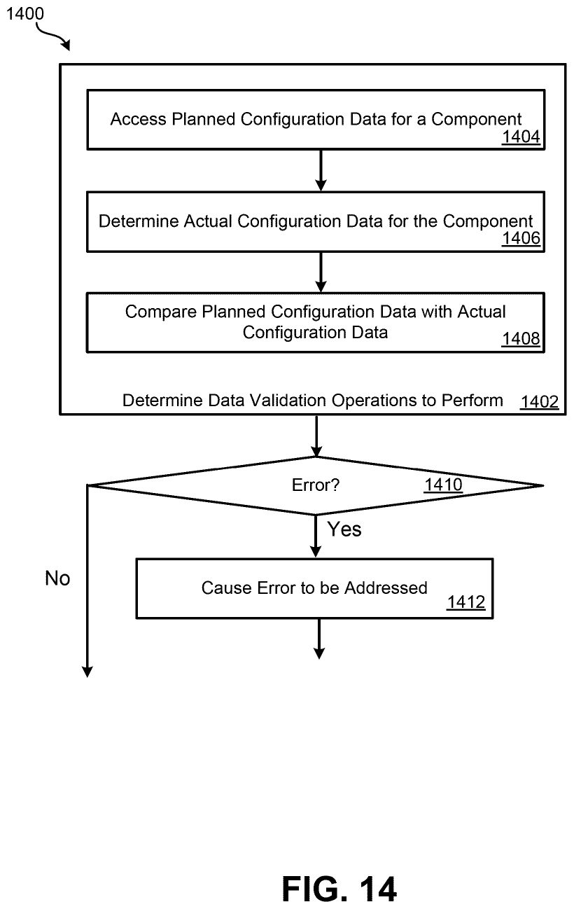

FIG. 14 is a flow diagram illustrating an example method 1400 for performing validation operations, according to various embodiments. The method 1400 may be implemented by one or more components, such as the automation manager 122, included in the systems described herein. Depending on the implementation, the method 1400 may include additional, fewer, or alternative steps performed in various orders or in parallel.

At 1402, the data validation operations/workflows to perform are determined. In some examples, the workflow engine 402 may communicate with the workflow management component 406, the inventory management system 404, or some other component, and/or the automation manager 122 to identify the workflows/operations to perform. In other examples, the validation operations to perform may be obtained from a GUI, such as associated with NOC 210. The data validation operations may involve obtaining planned configuration data for one or more components/devices installed at the cell site, obtaining actual configuration data for the components/devices, comparing the planned configuration data with the actual configuration data, and determining if an error occurred based, at least in part, on the comparing.

At 1404, the planned configuration data for a component/device is accessed. As discussed above, the automation manager 122 can directly communicates with the inventory management component 404 to obtain the planned configuration data for the component.

At 1406, the actual configuration data for a component/device is accessed. As discussed above, after a component/device (e.g., a DU NF, a server, . . . ) is installed at a cell site, a component, such as the automation manager 122 can directly communicates with the installed, or some other component described here to obtain the actual configuration data for the component.

At 1408, the planned configuration data is compared with the actual configuration data. As discussed above, a component/device can compare the planned configuration data is compared with the actual configuration data to determine if there are any differences/errors.

At 1410, a determination is made as to whether there is an error. As discussed above, the automation manager 122 can be configured to determine if there is an error based on the comparison of the planned configuration data is compared with the actual configuration data. When there is an error, the method moves to 1412. When there is not an error, the method can continue to process other actions.

At 1412, the error can be addressed. In some examples, a user, is notified of the validation error. In this case, the user may cause the error to be addressed. In other examples, an automatic operation may be performed in an attempt to address the error. For example, the component may be restarted, software associated with the component may be automatically updated, a rollback of the update to the version before the update was performed, and the like.

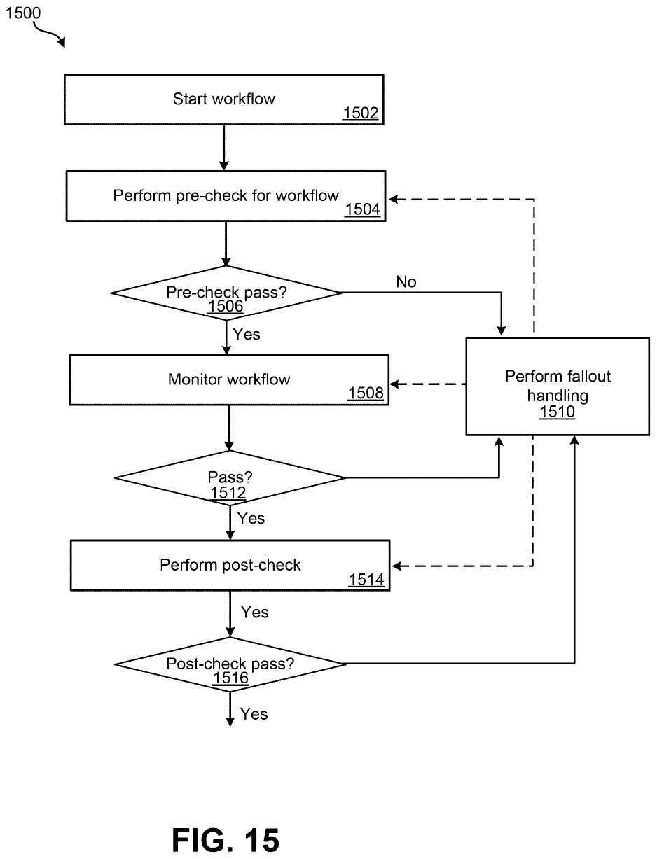

In FIG. 15, a validation and fallout handling method 1500 is provided in accordance with some embodiments. It will be described with references to figures described herein. The operations of method 1500 presented below are intended to be illustrative. In some embodiments, method 1500 may be accomplished with one or more additional operations not described and/or without one or more of the operations discussed. Additionally, the order in which the operations of method 1500 are illustrated in FIG. 15 and described below is not intended to be limiting.

In some embodiments, method 1500 may be implemented by a device including one or more of the processors, such as the ones shown in FIG. 1 The device may include a digital processor, an analog processor, a digital circuit designed to process information, an analog circuit designed to process information, a state machine, and/or other mechanisms for electronically processing information. The device may execute some or all of the operations of method 1500 in response to instructions stored electronically on an electronic storage medium. The device may include one or more components configured through hardware, firmware, and/or software to be designed for execution of one or more of the operations of method 1500.

At 1502, a workflow is started. As discussed above, a workflow may be a stage in a pipeline for performing tasks associated with automation operations and/or data validation operations. In other examples, a workflow may be associated with performing other operations. According to some examples, a workflow may be associated with changing one or more components from one vendor to another vendor, setting up devices in a core network of the O-RAN (e.g., within a cloud environment) as well as setting up devices in individual cell sites facilitating the O-RAN. In various examples, workflows managed by the workflow engine 402 and/or workflow management component 406 may include but are not limited to automation workflows, data validation workflows, RU workflows, computer host provisioning (CHP) workflows, virtual server management provisioning (VSMP) workflows (e.g., VMware vCenter provisioning (VCP)), node-pool creation (NPC) workflows, distributed unit instantiation (DUI) workflows, radio access network (RAN) initiation workflows, vendor RAN swapping workflows, C-RAN provisioning workflows, and/or other workflows. According to some embodiments, the workflows may be completed in a specified order, such as CHP workflow before execution a VSMP workflow, and the like.

At 1504, a pre-check validation can be performed by the validation engine 412. As discussed above, individual validation apps may be developed for different types of validation flows or pipelines. In various embodiments, the validation apps are configured with intelligence to handle corresponding validation flows. In various example, validation apps are developed for pre-checks for different ones of the workflows (e.g., EMU, RU, CHP, VCP, NPC, DUI, RAN, . . . ). In some examples, a validation worker places validation information regarding the execution of the validation job onto a message queue. The validation information may indicate whether the pre-check passed or did not pass.

At 1506, a determination is made as to whether the pre-check validation passed. When the pre-check validation passes, the process flows to 1508. When the pre-check validation does not pass, the process flows to 1-10 for fallout handling.

At 1508, the workflow is monitored. As discussed above, the validation engine 412, the workflow engine 402, or some other device/component may monitor the operations performed to determine whether the operations completed successfully. In some examples, a timeout is specified that indicates how long the execution of the operations associated with the current stage are allowed to take before an error is generated. For example, one stage may have a timeout of ten minutes, another stage may have a timeout of fifteen minutes, and the like. In this way, an error is detected in the stage in situations when the workflow is not progressing through the operations for the stage.

At 1510, fallout handling is performed. As discussed above, according to some embodiments, a fallout engine (not shown), the workflow engine 402, and/or some other device component performs fallout operations for the different points in the workflows (e.g., pre-check, monitoring performance of the ZTP operations for the stage, and post-check). When the fallout engine pauses the workflow (e.g., a hard fallout), then, after determining that the issue/error has been resolved, the fallout engine cause the workflow to resume at a point in the workflow prior to the occurrence of the error.

At 1514, a post-check is performed. As discussed above, the validation engine 412 may perform a post-check validation to determine whether the workflow performed the operations successfully.

At 1516, a determination is made as to whether the post-check validation passed. When the post-check validation passes, the process flows to 1516. When the post-check validation does not pass, the process flows to 1410.

At 1518, a determination is made as to whether there are more stages/workflows. When there are more stages, the process flows to 1504. When there are not more stages, the process ends and returns to processing other actions.

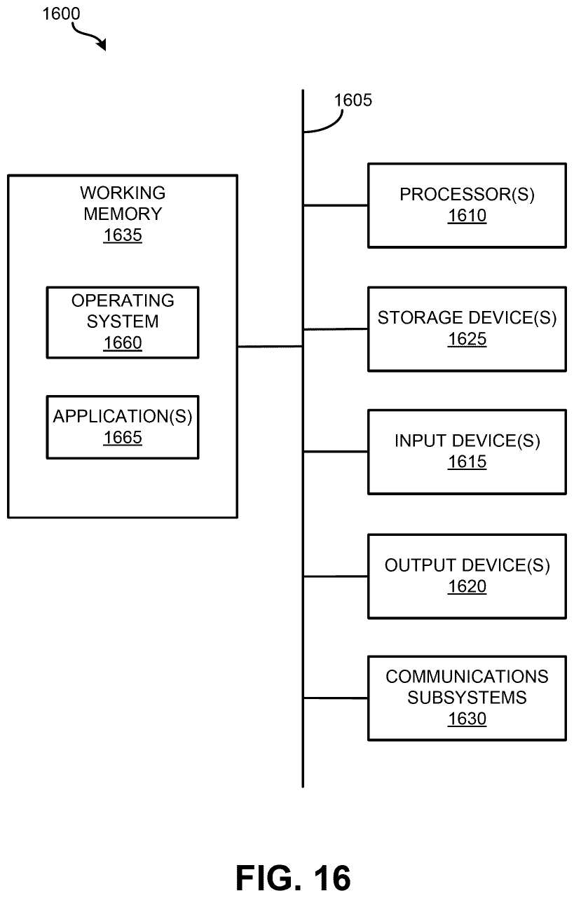

The system and other components in the systems described above may include a computer system that further includes computer hardware and software that form special-purpose network circuitry to implement various embodiments such as communication, calculation, artifact validation, functional testing, test environment configuration, and so on. FIG. 16 is a schematic diagram illustrating an example of computer system 1600. The computer system 1600 is a simplified computer system that can be used to implement various embodiments described and illustrated herein. A computer system 1600 as illustrated in FIG. 16 may be incorporated into devices such as a portable electronic device, mobile phone, server grade machines, or other device as described herein. FIG. 16 provides a schematic illustration of one example of a computer system 1600 that can perform some or all of the steps of the methods and workflows provided by various embodiments. It should be noted that FIG. 16 is meant only to provide a generalized illustration of various components, any or all of which may be utilized as appropriate. FIG. 16, therefore, broadly illustrates how individual system elements may be implemented in a relatively separated or relatively more integrated manner.

The computer system 1600 is shown including hardware elements that can be electrically coupled via a bus 1605, or may otherwise be in communication, as appropriate. The hardware elements may include one or more processors 1610, including without limitation one or more general-purpose processors and/or one or more special-purpose processors such as digital signal processing chips, graphics acceleration processors, and/or the like; one or more input devices 1615, which can include without limitation a mouse, a keyboard, a camera, and/or the like; and one or more output devices 1620, which can include without limitation a display device, a printer, and/or the like.

The computer system 1600 may further include and/or be in communication with one or more non-transitory storage devices 1625, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 1600 might also include a communications subsystem 1630, which can include without limitation a modem, a network card (wireless or wired), an infrared communication device, a wireless communication device, and/or a chipset such as a Bluetooth™ device, a 602.11 device, a WiFi device, a WiMax device, cellular communication facilities, etc., and/or the like. The communications subsystem 1630 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 1630. In other embodiments, a portable electronic device, e.g., the first electronic device, may be incorporated into the computer system 1600, e.g., an electronic device as an input device 1615. In some embodiments, the computer system 1600 will further include a working memory 1635, which can include a RAM or ROM device, as described above.

The computer system 1600 also can include software elements, shown as being currently located within the working memory 1635, including an operating system 1660, device drivers, executable libraries, and/or other code, such as one or more application programs 1665, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 16, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1625 described above. In some cases, the storage medium might be incorporated within a computer system, such as computer system 1600. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 1600 and/or might take the form of source and/or installable code, which, upon compilation and/or installation on the computer system 1600 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 1600 to perform methods in accordance with various embodiments of the technology. According to a set of embodiments, some or all of the operations of such methods are performed by the computer system 1600 in response to processor 1610 executing one or more sequences of one or more instructions, which might be incorporated into the operating system 1660 and/or other code, such as an application program 1665, contained in the working memory 1635. Such instructions may be read into the working memory 1635 from another computer-readable medium, such as one or more of the storage device(s) 1625. Merely by way of example, execution of the sequences of instructions contained in the working memory 1635 might cause the processor(s) 1610 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an example implemented using the computer system 1600, various computer-readable media might be involved in providing instructions/code to processor(s) 1610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1625. Volatile media include, without limitation, dynamic memory, such as the working memory 1635.

Common forms of physical and/or tangible computer-readable media include, for example, a floppy disk, a flexible disk, hard disk, magnetic tape, solid state drive, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1600.

The communications subsystem 1630 and/or components thereof generally will receive signals, and the bus 1605 then might carry the signals and/or the data, instructions, etc. carried by the signals to the working memory 1635, from which the processor(s) 1610 retrieves and executes the instructions. The instructions received by the working memory 1635 may optionally be stored on a non-transitory storage device 1625 either before or after execution by the processor(s) 1610.

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment”, “an embodiment”, “one example”, “an example” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “an artifact” includes a plurality of such artifacts, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A method, comprising:
receiving, by one or more processors, an indication to define an automation to be performed at cell sites of a cellular network;
determining, by the one or more processors, one or more operations to perform the automation;
determining, by the one or more processors and based at least in part on the one or more operations, first instructions associated with a first brand of a component deployed at one or more cell sites of the cellular network;
determining, by the one or more processors and based at least in part on the one or more operations, second instructions associated with a second brand of the component deployed at one or more cell sites of the cellular network;
associating, by the one or more processors, the first instructions with the automation and the second instructions with the automation; and
causing the automation to execute at one or more of the cell sites when determined.

2. The method of claim 1, further comprising causing a graphical user interface (GUI) to be displayed on a display associated with a user, wherein the GUI includes one or more automation user interface (UI) elements that indicates available automations, and one or more operations user interface (UI) elements that indicates available operations to include within one or more automations.

3. The method of claim 2, wherein determining the one or more operations to perform comprises receiving, from the one or more operations UI elements, a selection of at least a portion of the one or more operations.

4. The method of claim 2, wherein the GUI further includes one or more component UI elements that indicate one or more components associated with an operation of the automation.

5. The method of claim 2, wherein the GUI further includes one or more linking UI elements that when selected cause a selected automation to be linked with the automation.

6. The method of claim 1, further comprising:
receiving a second indication to link a second automation with the automation; and
linking the second automation to the automation.

7. The method of claim 2, wherein the GUI further includes one or more authorization UI elements that are configured to receive authorization data that indicates one or more users authorized to perform the automation.

8. The method of claim 1, further comprising associating, by the one or more processors, a first health check automation with the automation and a second health check automation with the automation, wherein the first health check automation is performed prior to performing the automation and the second health check automation is performed after performing the automation.

9. The method of claim 2, wherein the GUI further includes one or more state UI elements that indicate a current state of an operation, wherein the current state is selected from at least a failed state, a queued state, a running state, and a restarting state.

10. A system including one or more electronic processors configured to define operations to perform at one or more cell sites of a cellular network, wherein the system comprises:
components deployed at cell sites of the cellular network; and
an automation manager installed a location that is remote from the cell sites, the automation manager configured to perform actions, including to:
receive an indication to define an automation to be performed at cell sites of a cellular network;
determine one or more operations to perform the automation;
determine, based at least in part on the one or more operations, first instructions associated with a first brand of component deployed at one or more cell sites of the cellular network;
determine, based at least in part on the one or more operations, second instructions associated with a second brand of the component deployed at one or more cell sites of the cellular network;
associate the first instructions with the automation and the second instructions with the automation; and
cause the automation to execute at one or more of the cell sites when determined.

11. The system of claim 10, wherein the automation manager is further configured to cause a graphical user interface (GUI) to be displayed on a display associated with a user, wherein the GUI includes one or more automation user interface (UI) elements that indicates available automations, and one or more operations user interface (UI) elements that indicates available operations to include within one or more automations.

12. The system of claim 11, wherein determining the one or more operations to include within the automation comprises receiving, from the one or more operations UI elements, a selection of at least a portion of the one or more operations.

13. The system of claim 11, wherein the GUI further includes one or more component UI elements that indicate one or more components associated with an operation of the automation.

14. The system of claim 11, wherein the GUI further includes one or more linking UI elements that when selected cause a selected automation to be linked with the automation associated with an execution of the automation.

15. The system of claim 10, wherein the automation manager is further configured to:
receive a second indication to link a second automation with a first automation; and
link the second automation to the automation.

16. The system of claim 11, wherein the GUI further includes one or more authorization UI elements that are configured to receive authorization data that indicates one or more users authorized to perform the automation.

17. A non-transitory computer-readable medium configured to facilitate defining automations performed at cell sites of a cellular network, wherein the non-transitory computer-readable medium, when executed by a computer, causes the computer to:
receive an indication to define an automation to be performed at cell sites of a cellular network;
determine one or more operations to perform the automation;
determine, based at least in part on the one or more operations, first instructions associated with a first brand of component deployed at one or more cell sites of the cellular network;
determine, based at least in part on the one or more operations, second instructions associated with a second brand of the component deployed at one or more cell sites of the cellular network;
associate the first instructions with the automation and the second instructions with the automation; and
cause the automation to execute at one or more of the cell sites when determined.

18. The non-transitory computer-readable medium of claim 17, wherein the non-transitory computer-readable medium, when executed by the computer, further causes the computer to cause a graphical user interface (GUI) to be displayed on a display associated with a user, wherein the GUI includes one or more automation user interface (UI) elements that indicates available automations, and one or more operations user interface (UI) elements that indicates available operations to include within one or more automations.

19. The non-transitory computer-readable medium of claim 18, wherein the GUI further includes one or more component UI elements that indicate one or more components associated with an operation of the automation.

20. The non-transitory computer-readable medium of claim 18, wherein the GUI further includes one or more linking UI elements that when selected cause a selected automation to be linked with the automation associated with an execution of the one or more automations.
